(19) United States
(12) Patent Application Publication
(10) Pub. No.: US 2026/0370665 A1
(43) Pub. Date: Nov. 19, 2026

(54) SYSTEM FOR DECENTRALIZED ADVERSARIAL RESILIENT COLLABORATIVE CYBER THREAT DETECTION USING BLOCKCHAIN COORDINATED TRUSTED EXECUTION ENVIRONMENTS

(71) Applicant: Huda Ali ALATAWI, Tabuk (SA)

(72) Inventor: Huda Ali ALATAWI, Tabuk (SA)

(21) Appl. No.: 19/730,631

(22) Filed: Jul. 2, 2026

(51) Int. Cl. H04L 9/40; H04L 9/00; H04L 9/32

(52) U.S. Cl. CPC H04L 63/1416; H04L 9/008; H04L 9/3218; H04L 9/50

(57) ABSTRACT

The present invention discloses a system and method for decentralized cyber threat detection using blockchain and trusted execution environments. A telemetry processing unit processes network telemetry within a trusted execution environment using an intrusion detection model to generate an encrypted threat signature and a detection attestation package containing cryptographic verification information for a detected network event. A consensus validation unit validates the attestation package through blockchain-based validator selection and encrypted similarity evaluation by participating nodes. A blockchain record management unit records validated detection events, updates reputation information, and propagates encrypted threat signatures through a distributed ledger. A collaborative model update management unit validates proposed model updates within authenticated trusted execution environments before incorporation into a collaborative model state. A model-state history management unit records successive collaborative model states, while a cryptographic proof generation unit generates proofs verifying recorded threat detection events while preserving confidentiality of network telemetry and collaborative model information.

### FIELD OF THE INVENTION

The present invention generally relates to cybersecurity systems and secure distributed computing infrastructures. More particularly, the present invention relates to a decentralized cyber threat detection system employing hardware-protected execution environments, blockchain-based coordination, cryptographic validation, privacy-preserving collaborative threat intelligence, and distributed collaborative learning for secure detection, validation, and verification of cyber threats across multiple participating network nodes.

### BACKGROUND OF THE INVENTION

Modern enterprise computing environments comprise interconnected cloud infrastructures, edge devices, data centers, industrial control systems, virtualized computing platforms, and Internet-connected communication networks. As cyberattacks become increasingly sophisticated, attackers employ zero-day exploits, polymorphic malware, ransomware, advanced persistent threats, and coordinated attacks capable of bypassing conventional intrusion detection mechanisms.

Conventional cybersecurity solutions generally operate independently within organizational boundaries and are unable to securely exchange newly identified threat intelligence without exposing sensitive network telemetry, proprietary infrastructure information, or confidential operational data. Consequently, collaborative identification and mitigation of emerging cyber threats are delayed, leaving multiple organizations vulnerable until threat intelligence is manually validated and distributed.

Centralized threat intelligence platforms introduce additional limitations including single points of failure, dependence on trusted third parties, increased communication latency, limited scalability, and reduced assurance regarding authenticity and provenance of shared threat information. Although federated learning enables collaborative model refinement without exchanging raw data, conventional federated learning frameworks remain vulnerable to model poisoning attacks, malicious participant manipulation, incompatible model updates, rollback attacks, and limited mechanisms for validating the authenticity of contributed updates before incorporation into a collaborative model.

Blockchain technologies have been introduced for maintaining immutable security records; however, conventional blockchain implementations primarily function as passive logging mechanisms and do not actively participate in collaborative threat validation, decentralized model governance, or secure propagation of encrypted threat intelligence. Likewise, Trusted Execution Environments (TEEs) provide hardware-assisted isolation for security-sensitive computations, but existing deployments generally protect computations within individual devices and do not establish authenticated trust relationships among multiple Trusted Execution Environments operating across decentralized organizational infrastructures. Another limitation of existing collaborative cybersecurity platforms relates to secure exchange of threat intelligence among mutually untrusted organizations. Conventional threat-sharing mechanisms typically require disclosure or decryption of malware signatures, attack indicators, packet fingerprints, or behavioural characteristics before comparison with locally observed traffic, increasing the risk of information leakage. Existing privacy-preserving approaches based on Secure Multi-Party Computation or encrypted databases often introduce substantial computational complexity and communication overhead, limiting their applicability to real-time collaborative threat detection. Accordingly, there exists a need for an improved decentralized cybersecurity architecture capable of securely coordinating collaborative threat detection while preserving confidentiality of proprietary network telemetry. There is a further need for a system that integrates Trusted Execution Environments, blockchain-based coordination, privacy-preserving cryptographic validation, secure collaborative model update validation, immutable model-state provenance, and verifiable forensic disclosure within a unified cybersecurity framework to provide authenticated and privacy-preserving collaborative cyber threat detection across multiple participating organizations.

### SUMMARY OF THE INVENTION

The present invention provides a decentralized adversarial-resilient cyber threat detection and response system comprising a plurality of organizational computing nodes interconnected through a distributed blockchain communication network. Each organizational node incorporates a processor, memory, network communication interface, trusted execution enclave, intrusion detection processing unit, threat signature generation unit, cryptographic processing unit, and local telemetry acquisition unit configured to continuously monitor network activities.

The trusted execution enclave securely executes an intrusion detection engine while protecting executable code, model parameters, cryptographic credentials, and intermediate computational states from unauthorized access by the host operating system or malicious software.

Upon detecting suspicious network activity, the intrusion detection processing unit generates a detection attestation package containing cryptographic evidence associated with the detection event. The threat signature generation unit converts the detected anomaly into an encrypted homomorphic threat signature vector that is committed to the blockchain network through a Proof-of-Detection consensus protocol.

Validator nodes independently authenticate the received detection evidence, perform encrypted similarity analysis using locally encrypted telemetry, evaluate detection credibility, and collectively determine whether the proposed threat should be accepted. Following consensus, the validated threat signature is propagated throughout the decentralized network, enabling participating organizations to identify similar threats without decrypting either the propagated signature or locally stored network telemetry.

The invention further incorporates a multi-phase adversarial consensus validation mechanism for evaluating proposed federated learning updates before modifying the collective detection model. Model state transitions are permanently anchored to blockchain block heights, thereby creating an immutable chain of cryptographically verifiable model provenance. Selective forensic disclosure mechanisms further enable authorized entities to verify detection legitimacy through zero-knowledge proofs while preserving confidentiality of operational data.

The primary object of the present invention is to provide a decentralized adversarial-resilient cyber threat detection and response system capable of facilitating secure, real-time collaborative identification and mitigation of cyber threats across multiple independent organizational networks while preserving the confidentiality, integrity, and ownership of locally generated network telemetry and security information.

Another object of the present invention is to provide a cybersecurity architecture that incorporates hardware-protected trusted execution environments for securely executing threat detection operations, safeguarding executable code, computational states, model parameters, and cryptographic credentials from unauthorized access, tampering, or manipulation by external software or privileged system components.

Another object of the present invention is to provide a blockchain-coordinated validation mechanism that enables participating organizational nodes to collectively verify detected cyber threats through a decentralized consensus process, thereby eliminating reliance on centralized trust authorities while ensuring authenticity, traceability, and immutability of threat intelligence records.

Another object of the present invention is to provide a decentralized reputation management mechanism configured to dynamically evaluate the reliability and historical performance of participating organizational nodes based on validated threat detection contributions, thereby improving the accuracy, trustworthiness, and resilience of collaborative cybersecurity operations. Another object of the present invention is to provide a temporal model state anchoring mechanism configured to cryptographically associate successive model state transitions with corresponding blockchain records, thereby establishing an immutable chain of model provenance that enables reconstruction, verification, and auditing of cybersecurity decisions throughout the operational lifecycle of the system.

Another object of the present invention is to provide a selective forensic disclosure mechanism configured to generate cryptographically verifiable proofs demonstrating the legitimacy of cyber threat detection events while preventing disclosure of confidential network telemetry, proprietary model parameters, organizational infrastructure information, or other sensitive operational data.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a flow chart of a computer-implemented method for decentralized adversarial-resilient cyber threat detection, the method being performed by one or more processors in communication with a memory in accordance with an embodiment of the present invention;

FIG. 2 displays a block diagram for a decentralized adversarial-resilient cyber threat detection system in accordance with an embodiment of the present invention;

FIG. 3 illustrates exemplary three-layer architecture of the decentralized collaborative cyber threat detection system including an Enclave Execution Layer, a Blockchain Coordination Layer, and a Cryptographic Services Layer.

FIG. 4 illustrates an exemplary workflow of a Proof-of-Detection (PoD) consensus protocol for collaborative validation of detected cyber threats using Trusted Execution Environment (TEE) attestation, validator selection, encrypted corroboration, and threshold-based consensus.

FIG. 5 illustrates an exemplary workflow for generating, propagating, and validating a Homomorphic Threat Signature Vector (HTSV) through threshold homomorphic encryption and encrypted similarity evaluation among participating network nodes.

FIG. 6 illustrates an exemplary Multi-Phase Adversarial Consensus Validation (MACV) protocol for secure validation of collaborative model updates through gradient commitment, selective revelation, adversarial robustness evaluation, and threshold-based acceptance.

FIG. 7 illustrates an exemplary Temporal Gradient Anchoring (TGA) chain for cryptographically tracking successive collaborative model states and a Selective Forensic Disclosure (SFD) protocol utilizing Zero-Knowledge Proofs (ZKP) for privacy-preserving verification of validated threat detection events.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment. The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises ... a” does not, without more constraints, preclude the existence of other devices or other sub-systems or other elements or other structures or other components or additional devices or additional sub-systems or additional elements or additional structures or additional components. Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

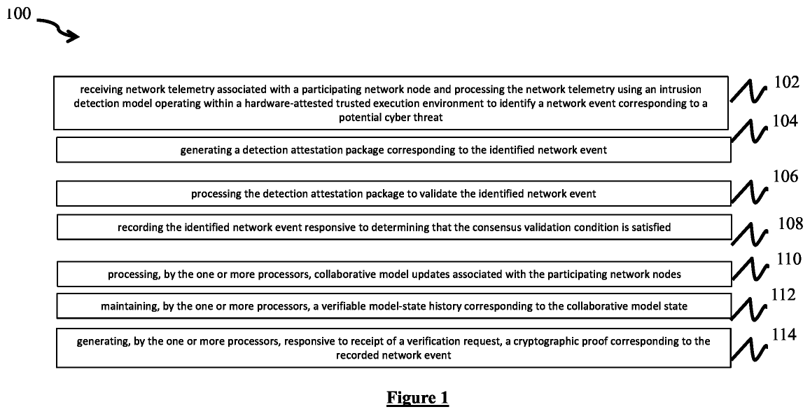

Referring to FIG. 1, a flow chart for a computer-implemented method for decentralized adversarial-resilient cyber threat detection, the method being performed by one or more processors in communication with a memory is illustrated. The system 100 comprises:

At step 102, the method 100 includes receiving, by the one or more processors, network telemetry associated with a participating network node and processing the network telemetry using an intrusion detection model operating within a hardware-attested trusted execution environment to identify a network event corresponding to a potential cyber threat, wherein processing the network telemetry comprises generating a latent feature representation corresponding to the identified network event, generating a cryptographic commitment representative of the processed network telemetry, and associating the latent feature representation with identity information and version information of the intrusion detection model maintained within the hardware-attested trusted execution environment.

At step 104, the method 100 includes generating, by the one or more processors, a detection attestation package corresponding to the identified network event, wherein generating the detection attestation package comprises encrypting the latent feature representation using a threshold homomorphic encryption scheme to obtain an encrypted threat signature, cryptographically binding the encrypted threat signature with the cryptographic commitment, the identity information, the version information, and a blockchain state reference corresponding to a current blockchain state to produce a cryptographically verifiable threat detection record, and transmitting the detection attestation package to a blockchain network.

At step 106, the method 100 includes processing, by the one or more processors, the detection attestation package to validate the identified network event, wherein processing the detection attestation package comprises verifying authenticity of a hardware attestation associated with the detection attestation package, selecting a plurality of validator nodes according to a blockchain consensus procedure, generating encrypted telemetry representations from network telemetry locally available at the selected validator nodes using a feature transformation corresponding to generation of the encrypted threat signature, performing homomorphic similarity computation between the encrypted threat signature and the encrypted telemetry representations while maintaining the encrypted threat signature and the encrypted telemetry representations in encrypted form throughout the similarity computation, generating encrypted corroboration information according to similarity results obtained from the homomorphic similarity computation, and determining whether the encrypted corroboration information satisfies a consensus validation condition.

At step 108, the method 100 includes recording, by the one or more processors, the identified network event responsive to determining that the consensus validation condition is satisfied, wherein recording comprises storing the encrypted threat signature and the detection attestation package within a blockchain record, updating a reputation value associated with the participating network node according to the validated network event, associating the updated reputation value with subsequent collaborative model contribution and blockchain participation, and propagating the encrypted threat signature to participating network nodes for encrypted comparison with locally generated encrypted telemetry representations without exposing underlying network telemetry associated with the participating network nodes.

At step 110, the method 100 includes processing, by the one or more processors, collaborative model updates associated with the participating network nodes, wherein processing the collaborative model updates comprises receiving cryptographic commitments corresponding to proposed model updates, selectively exposing the proposed model updates to the selected validator nodes through authenticated secure communication established between hardware-attested trusted execution environments, generating encrypted validation information corresponding to robustness evaluation performed for the proposed model updates, determining acceptance of the proposed model updates according to the encrypted validation information received from the selected validator nodes, incorporating accepted model updates into a collaborative model state, rejecting model updates failing acceptance, and recording an outcome corresponding to each proposed model update within the blockchain record.

At step 112, the method 100 includes maintaining, by the one or more processors, a verifiable model-state history corresponding to the collaborative model state, wherein maintaining the verifiable model-state history comprises generating a model-state anchor for each accepted model update, cryptographically linking each model-state anchor with a preceding model-state anchor and a blockchain block corresponding to acceptance of the accepted model update, storing cryptographic hashes representative of the collaborative model state and training-data commitments within the model-state anchor, and preserving a chronological model provenance corresponding to successive collaborative model updates.

At step 114, the method 100 includes generating, by the one or more processors, responsive to receipt of a verification request, a cryptographic proof corresponding to the recorded network event, wherein generating the cryptographic proof comprises retrieving a model-state anchor corresponding to the recorded network event, constructing the cryptographic proof using the retrieved model-state anchor, the blockchain record, and the hardware attestation associated with the detection attestation package, and providing the cryptographic proof for verification of the recorded network event while retaining confidentiality of the network telemetry, the collaborative model state, and the encrypted threat signature.

In an embodiment, a blockchain state reference represents information identifying a current operational state of a distributed blockchain ledger corresponding to generation, validation, recording, or verification of a detection event. The blockchain state reference may comprise one or more of a blockchain block identifier, block height, transaction identifier, ledger sequence number, consensus epoch identifier, synchronization sequence, timestamp, previous block hash, or combinations thereof. The blockchain state reference enables participating network nodes to associate generated detection information, validation information, collaborative model updates, and recorded blockchain records with a common ledger state so that subsequent validation, reconstruction, synchronization, and verification operations are performed relative to an identical blockchain condition. Identity information represents authenticated information uniquely identifying the trusted execution environment or participating network node responsible for generating a corresponding detection attestation package, collaborative model update, or cryptographic evidence, while version information represents information identifying the computational configuration, parameter configuration, feature transformation configuration, processing configuration, or revision of the intrusion detection model employed during generation of the corresponding information.

In an embodiment, a collaborative model state represents a synchronized computational state of the intrusion detection model collectively maintained by participating network nodes following incorporation of one or more accepted collaborative model updates. A model-state anchor represents a cryptographically verifiable record corresponding to a particular collaborative model state and comprises one or more cryptographic hashes, blockchain associations, chained references, version identifiers, training-data commitments, and synchronization information that collectively enable reconstruction, verification, provenance determination, and chronological tracking of successive collaborative model states. A training-data commitment represents a cryptographic commitment corresponding to training information utilized during generation of an accepted collaborative model update without revealing the underlying training telemetry or associated confidential information, thereby enabling subsequent verification of model provenance while preserving confidentiality of locally maintained training information.

In an embodiment, a consensus validation condition represents one or more predetermined validation criteria evaluated using encrypted corroboration information generated by a plurality of validator nodes during decentralized validation of a detected network event or collaborative model update. The consensus validation condition may be determined according to one or more of validator participation, encrypted similarity evaluation, encrypted confidence information, integrity verification information, synchronization status, validator agreement, reputation values associated with participating network nodes, or combinations thereof. Responsive to determining satisfaction of the consensus validation condition, the corresponding detection event or collaborative model update is accepted for blockchain recording or incorporation into the collaborative model state; otherwise, the corresponding information is rejected, subjected to additional validation processing, or retained for subsequent verification without affecting the synchronized collaborative model state In an embodiment, the computer-implemented method described herein achieves the technical effect of providing decentralized and cryptographically verifiable cyber threat detection through coordinated processing performed by the telemetry processing unit, detection attestation generation unit, consensus validation unit, blockchain record management unit, collaborative model update management unit, model-state history management unit, and cryptographic proof generation unit. Generation of the encrypted threat signature from monitored network telemetry and incorporation of the encrypted threat signature within the Detection Attestation Package enables participating network nodes to collaboratively validate detected network events without obtaining access to the underlying network telemetry. Independent homomorphic similarity evaluation performed by validator nodes, followed by consensus validation using encrypted corroboration information, reduces acceptance of isolated or manipulated detections while maintaining confidentiality of locally generated telemetry. Recording validated detection events together with corresponding blockchain state references and reputation values establishes a cryptographically verifiable and chronologically ordered record of validated threat intelligence. Validation of collaborative model updates before incorporation into the collaborative model state, generation of successive model-state anchors corresponding to accepted collaborative model updates, and generation of cryptographic proofs associated with recorded detection events collectively establish authenticated model provenance and verifiable forensic evidence while preserving confidentiality of collaborative model information and network telemetry throughout decentralized operation.

In an embodiment, processing the network telemetry comprises sequentially extracting network communication attributes from a plurality of telemetry records, normalizing the extracted network communication attributes into a common representation, correlating the normalized network communication attributes across multiple communication sessions associated with the participating network node to construct a unified behavioural representation of the network event, processing the unified behavioural representation using the intrusion detection model to generate intermediate feature values representing communication behaviour associated with the network event, transforming the intermediate feature values into the latent feature representation while maintaining positional correspondence between the intermediate feature values and the latent feature representation, generating the cryptographic commitment from the processed telemetry associated with the network event after generation of the latent feature representation, and associating the cryptographic commitment with the identity information and the version information of the intrusion detection model before generation of the detection attestation package. For example, during a monitoring interval of 500 milliseconds, approximately 18,000 telemetry records may be collected from firewall events, endpoint communication logs, and network traffic monitors. The telemetry processing unit aligns the timestamps within a tolerance of ±2 milliseconds to ensure that events generated by different monitoring interfaces correspond to the same communication activity before subsequent processing is performed.

Following synchronization, the telemetry processing unit sequentially extracts network communication attributes from each telemetry record to generate structured communication descriptors. The extracted attributes represent measurable characteristics of network behaviour and may include source network address, destination network address, transport protocol identifier, communication port identifier, packet length, communication duration, packet transmission interval, connection establishment sequence, session identifier, payload size, packet arrival frequency, protocol state transitions, authentication status, communication direction, retransmission count, and resource access information. The extraction process is performed using predefined parsing rules corresponding to individual telemetry formats so that each telemetry record is converted into a standardized attribute vector irrespective of its original source. For instance, a communication session comprising 250 transmitted packets may produce an attribute vector containing 64 normalized communication parameters, including an average packet size of 840 bytes, a mean transmission interval of 12 milliseconds, a session duration of 3.4 seconds, and a packet retransmission ratio of 1.8%, thereby providing a consistent numerical representation of the communication behaviour.

After extraction of the communication attributes, the telemetry processing unit normalizes the extracted attributes into a common representation suitable for subsequent behavioural analysis. Normalization reduces disparities resulting from different measurement units, numerical scales, and categorical encodings used by the various monitoring sources. Numerical parameters such as packet size, communication frequency, session duration, and bandwidth utilization are converted into predefined numerical ranges using scaling functions, while categorical parameters such as communication protocols, service identifiers, and authentication states are transformed into encoded numerical representations maintaining unique correspondence with their original values. Missing attribute values are estimated using neighbouring telemetry observations associated with the same communication session, whereas abnormal values exceeding predetermined operational thresholds are clipped or weighted to prevent disproportionate influence during feature generation. For example, packet sizes varying between 64 bytes and 1500 bytes may be normalized into values ranging from 0.0 to 1.0, while communication durations extending from 10 milliseconds to 20 seconds may be proportionally transformed into a normalized temporal scale, thereby enabling consistent processing of communication sessions exhibiting substantially different characteristics. Rather than analysing individual telemetry records independently, the telemetry processing unit correlates the normalized communication attributes across multiple communication sessions associated with the participating network node to construct a unified behavioural representation corresponding to the observed network event. The correlation process identifies logical relationships among successive communication sessions by comparing common device identifiers, user identifiers, process identifiers, network addresses, temporal proximity, protocol sequences, and resource access patterns. Communication sessions exhibiting predetermined correlation characteristics are grouped into a single behavioural sequence representing the progression of a network activity over time. As an illustrative example, five independent communication sessions initiated within a two-second interval from the same computing device may individually appear legitimate; however, when correlated together, the sessions may collectively exhibit repetitive authentication attempts, sequential access to privileged network resources, and increasing outbound communication frequencies indicative of credential misuse or unauthorized lateral movement. Constructing the unified behavioural representation therefore enables identification of complex attack scenarios that would otherwise remain undetected when analysing isolated communication records.

The unified behavioural representation is subsequently processed within the hardware-attested trusted execution environment by the intrusion detection model to generate intermediate feature values representative of the communication behaviour associated with the identified network event. The trusted execution environment provides an isolated execution region wherein executable instructions, processing memory, model parameters, intermediate computational states, and generated feature values remain inaccessible to external software executing on the host computing platform. During execution, the intrusion detection model performs successive computational transformations upon the behavioural representation, wherein each processing stage extracts progressively higher-order behavioural characteristics from the correlated communication data. Initial processing stages identify temporal communication trends and protocol interaction sequences, intermediate stages determine statistical relationships among correlated communication attributes, and subsequent stages generate compact behavioural descriptors that preserve the essential characteristics of the observed communication behaviour while reducing redundant information. For example, an initial behavioural representation comprising approximately 320 normalized communication attributes collected from multiple sessions may be progressively transformed into 128 intermediate feature values that accurately characterize communication periodicity, session continuity, protocol transitions, authentication consistency, and data transfer behaviour associated with the monitored network event.

The intermediate feature values are thereafter transformed into a latent feature representation while maintaining positional correspondence between the intermediate feature values and the generated latent feature representation. Positional correspondence denotes preservation of the logical relationship between each behavioural characteristic represented by an intermediate feature value and its corresponding location within the latent feature representation. Instead of randomly rearranging feature positions during dimensional transformation, the telemetry processing unit maintains deterministic positional mapping so that related behavioural characteristics occupy corresponding computational positions across different network events. This positional consistency facilitates reliable encrypted similarity computations performed by validator nodes during subsequent consensus validation without requiring reconstruction of the original telemetry. As an illustrative example, an intermediate feature group representing communication timing behaviour may consistently correspond to latent feature positions 10 through 18, whereas authentication-related characteristics may consistently occupy positions 42 through 55 within a 128-dimensional latent feature representation, thereby preserving semantic consistency among independently generated feature representations across participating network nodes.

Following successful generation of the latent feature representation, the telemetry processing unit generates a cryptographic commitment corresponding to the processed telemetry associated with the identified network event. The cryptographic commitment serves as a unique computational fingerprint representing the processed telemetry without revealing the underlying communication information. Generation of the cryptographic commitment is intentionally deferred until completion of latent feature generation so that the commitment accurately represents the finalized processed telemetry rather than intermediate computational states. The processed telemetry together with selected metadata, including timestamp information, communication session identifiers, and preprocessing configuration parameters, is supplied to a cryptographic hash generation procedure that produces a fixed-length commitment value. For example, telemetry corresponding to approximately 12 MB of processed communication data may produce a 256-bit cryptographic commitment, wherein any subsequent modification of even a single telemetry attribute results in a completely different commitment value, thereby enabling reliable verification of data integrity during later stages of decentralized validation.

The generated cryptographic commitment is then associated with the identity information and version information of the intrusion detection model before generation of the detection attestation package. The identity information uniquely identifies the authenticated execution instance responsible for generating the detection result, while the version information specifies the precise computational configuration, parameter set, and behavioural processing logic employed during feature generation. Associating these elements ensures that every latent feature representation can be unequivocally traced to the exact detection model and execution context from which it originated. For example, when two participating network nodes execute different revisions of the intrusion detection model, such as version 3.2.1 and version 3.3.0, the version information enables subsequent validator nodes to determine compatibility between generated latent feature representations before performing encrypted similarity evaluation. This association minimizes inconsistencies arising from heterogeneous model deployments, improves reproducibility of collaborative validation, and establishes a verifiable processing lineage linking processed telemetry, generated feature representations, cryptographic commitments, and authenticated execution environments prior to construction of the detection attestation package.

In an embodiment, generating the detection attestation package comprises generating the encrypted threat signature from the latent feature representation before generation of the blockchain state reference, combining the encrypted threat signature, the cryptographic commitment, the identity information, the version information and the blockchain state reference into a single ordered data structure, generating a cryptographic digest over the ordered data structure, incorporating the cryptographic digest into the detection attestation package as an integrity verification value, verifying consistency between the identity information and the version information before transmission of the detection attestation package, and preventing modification of the encrypted threat signature after generation of the cryptographic digest by maintaining the cryptographic digest in association with the transmitted detection attestation package. As an illustrative example, the latent feature representation may comprise 128 feature values represented using floating-point precision, each value lying within a normalized range of −1.0 to +1.0. The detection attestation generation unit partitions the latent feature representation into a plurality of computational segments, such as eight segments each containing sixteen feature values, and sequentially encrypts each computational segment using a threshold encryption context established among participating network nodes. Each encrypted computational segment preserves the positional correspondence of the original feature values while rendering the numerical values computationally inaccessible without participation of the predefined threshold of authorized nodes. The encrypted computational segments are subsequently associated according to their original sequence to generate the encrypted threat signature, thereby preserving behavioural continuity without retaining the plaintext latent representation beyond the protected execution environment.

After completion of the encrypted threat signature, the detection attestation generation unit retrieves a blockchain state reference corresponding to the operational condition of the blockchain network at the time the detection attestation package is being assembled. The blockchain state reference represents a synchronization parameter that enables subsequent validator nodes to associate the detection event with a unique point in the distributed ledger. Depending upon implementation requirements, the blockchain state reference may comprise a block identifier, block height, consensus epoch identifier, ledger synchronization sequence, previous block hash, timestamp identifier, transaction sequence number, or a combination thereof. For example, if the participating blockchain currently maintains block number 845,720 and consensus epoch 12,487, both values may collectively constitute the blockchain state reference, thereby allowing every validator node to process the detection attestation package relative to an identical ledger state. Retrieving the blockchain state reference only after completion of encryption minimizes the possibility that changes in blockchain synchronization influence the generation of the encrypted threat signature and ensures deterministic creation of cryptographic evidence corresponding solely to the detected network event.

Following generation of the encrypted threat signature and retrieval of the blockchain state reference, the detection attestation generation unit combines the encrypted threat signature, the cryptographic commitment, the identity information, the version information, and the blockchain state reference into a single ordered data structure. The ordered data structure represents a predefined computational arrangement wherein each constituent element occupies a predetermined position irrespective of the participating network node generating the package.

Maintaining a consistent ordering enables every participating validator node to independently reconstruct an identical computational representation before performing integrity verification. For example, the ordered data structure may begin with a package header identifying the packet format, followed by the encrypted threat signature occupying the first computational section, the cryptographic commitment occupying the second section, the identity information occupying the third section, the version information occupying the fourth section, and the blockchain state reference occupying the final section before generation of integrity values. Each section may include predetermined length indicators and delimiter values to prevent ambiguity during parsing. Consequently, every validator node interprets the transmitted information according to an identical structural arrangement, thereby eliminating inconsistencies caused by variable field ordering or implementation-specific serialization methods.

Upon completion of the ordered data structure, the detection attestation generation unit generates a cryptographic digest over the complete ordered data structure. The cryptographic digest represents a fixed-length integrity value uniquely corresponding to every bit contained within the assembled structure. During generation of the digest, the ordered data structure is sequentially processed through a cryptographic transformation function that produces a deterministic output irrespective of the processing node performing the operation. Even a minor alteration, such as modification of a single encrypted computational segment or replacement of one character within the version information, results in a substantially different digest value, thereby enabling immediate detection of unauthorized modifications. For instance, an ordered data structure having a size of approximately 6 kilobytes may produce a 256-bit cryptographic digest that uniquely represents the complete package contents. Since the digest is generated after all constituent elements have been assembled, the integrity value simultaneously protects the encrypted threat signature, cryptographic commitment, identity information, version information, and blockchain state reference as a single computational entity rather than as separate independent values.

The generated cryptographic digest is then incorporated into the detection attestation package as an integrity verification value that accompanies the remaining package contents throughout subsequent transmission and validation processes. The integrity verification value is stored together with the ordered data structure in a predefined package format, enabling each validator node to independently regenerate the cryptographic digest from the received ordered data structure and compare the regenerated value with the transmitted integrity verification value. Matching digest values confirm that the received detection attestation package has remained unchanged during storage, transmission, and blockchain dissemination. As an illustrative example, when the detection attestation package is propagated through twenty participating validator nodes distributed across different geographical regions, each validator independently reconstructs the ordered data structure and regenerates the cryptographic digest. If all regenerated digest values match the transmitted integrity verification value, the package is accepted for subsequent consensus processing. Conversely, if one validator observes a mismatch resulting from accidental corruption or unauthorized modification of the encrypted threat signature, the validator immediately rejects the package without initiating computationally expensive encrypted similarity operations, thereby improving validation efficiency while preserving the integrity of collaborative threat detection.

Before transmission of the detection attestation package to the blockchain network, the detection attestation generation unit verifies consistency between the identity information and the version information maintained within the trusted execution environment. The identity information uniquely identifies the authenticated execution instance responsible for generating the encrypted threat signature, whereas the version information specifies the software configuration, behavioural processing logic, parameter configuration, and computational revision employed during feature generation. The consistency verification process confirms that both elements originate from the same authenticated execution context and correspond to a valid operational configuration recognized by the participating network. During verification, the identity information is compared with authenticated execution records maintained within the protected memory of the trusted execution environment, while the version information is compared with locally maintained model registration records representing approved intrusion detection configurations. For example, if the authenticated execution environment reports execution instance identifier “Node-174A” associated with model version “4.2.0,” whereas the assembled detection attestation package inadvertently contains version “4.1.7,” the inconsistency is detected before transmission, preventing generation of incompatible threat signatures that could otherwise produce erroneous similarity evaluations at validator nodes. This verification process therefore establishes computational consistency between the execution environment and the generated detection evidence before decentralized validation commences.

After successful consistency verification, the detection attestation package is finalized and prepared for transmission while ensuring that the encrypted threat signature cannot be modified following generation of the cryptographic digest. Rather than recalculating integrity information after every subsequent operation, the detection attestation generation unit maintains the generated cryptographic digest in continuous association with the transmitted detection attestation package throughout its lifecycle. Whenever the package is temporarily buffered, transmitted across communication channels, replicated within blockchain transactions, or retrieved for validator processing, the associated digest accompanies the package as an immutable integrity reference. Any attempt to modify the encrypted threat signature, replace computational segments, alter identity information, or substitute an alternative blockchain state reference immediately invalidates the existing digest because the regenerated digest no longer corresponds to the originally transmitted integrity verification value. Consequently, validator nodes can identify unauthorized alterations before executing consensus operations, thereby ensuring that every participating node performs encrypted similarity computation upon identical threat intelligence derived from the authenticated execution environment. Maintaining this immutable association between the encrypted threat signature and the cryptographic digest significantly improves reliability of decentralized validation, preserves evidentiary integrity of recorded cyber threat events, minimizes propagation of inconsistent threat information across the blockchain network, and establishes a verifiable chain linking the generated encrypted threat signature with the authenticated processing environment and corresponding blockchain state.

In an embodiment, processing the detection attestation package comprises selecting the plurality of validator nodes according to participation information maintained within the blockchain network, distributing the detection attestation package to each selected validator node without exposing the network telemetry corresponding to the identified network event, generating, at each selected validator node, the encrypted telemetry representation from locally available network telemetry using the feature transformation corresponding to generation of the encrypted threat signature, performing homomorphic similarity computation independently for each encrypted telemetry representation received from the selected validator nodes, generating the encrypted corroboration information individually for respective validator nodes, aggregating the encrypted corroboration information received from the selected validator nodes into a consolidated validation dataset, and determining satisfaction of the consensus validation condition according to the consolidated validation dataset. For example, in a blockchain network comprising 500 participating nodes, approximately 25 validator nodes may be selected for a particular validation cycle by identifying nodes exhibiting ledger synchronization exceeding 99.8%, cumulative participation scores above 0.85 on a normalized scale, and communication latency below 40 milliseconds. Periodic redistribution of validation responsibilities prevents concentration of validation authority among a limited subset of nodes while ensuring that validator selection remains adaptive to changing network conditions.

In an embodiment, following validator selection, the consensus validation unit distributes the Detection Attestation Package (DAP) to the selected validator nodes through authenticated communication channels established between participating network nodes. The Detection Attestation Package comprises an encrypted threat signature, a cryptographic commitment, identity information, version information, a blockchain state reference, and integrity verification information, while excluding the original network telemetry. Accordingly, participating validator nodes receive sufficient information to perform collaborative validation without accessing confidential telemetry associated with the originating participating network node.

Upon receiving the Detection Attestation Package, each validator node retrieves locally generated network telemetry corresponding to a predefined observation interval associated with the received detection event. The observation interval is determined according to the blockchain state reference or synchronization parameters maintained by the blockchain network to enable comparison of temporally corresponding communication activities.

Each validator node processes the locally generated network telemetry using processing operations corresponding to those employed by the originating participating network node, including feature extraction, parameter normalization, behavioural correlation, and feature representation generation. The resulting feature representation is encrypted using the same threshold homomorphic encryption context applied to the encrypted threat signature to generate an encrypted telemetry representation suitable for encrypted comparison.

The validator node subsequently performs homomorphic similarity computation between the received encrypted threat signature and the locally generated encrypted telemetry representation while maintaining both representations in encrypted form. During the computation, corresponding encrypted feature values are processed to generate an encrypted similarity representation without exposing the original feature values or the underlying network telemetry.

Following completion of the homomorphic similarity computation, the validator node determines whether the encrypted similarity representation satisfies one or more predefined validation thresholds using encrypted comparison procedures. Responsive to satisfaction of the validation thresholds, the validator node determines that the locally observed communication behaviour corresponds to the detected network event; otherwise, the validator node determines that insufficient behavioural correspondence exists for collaborative validation.

The validator node thereafter generates encrypted corroboration information comprising an encrypted similarity indicator, validator identification information, encrypted confidence information, validation timestamps, blockchain synchronization information, and integrity verification information. The encrypted corroboration information is transmitted to the consensus validation unit while maintaining confidentiality of the locally generated telemetry and validation results.

The consensus validation unit receives encrypted corroboration information from the validator nodes and generates a consolidated validation dataset by organizing the encrypted corroboration information according to validator identifiers, blockchain state references, and chronological order. The consolidated validation dataset preserves correspondence between individual validation results and participating validator nodes without decrypting the encrypted corroboration information.

The consensus validation unit processes the consolidated validation dataset according to predetermined consensus evaluation criteria to determine whether a consensus validation condition has been satisfied. In one embodiment, the evaluation considers validator participation, encrypted confidence information, validation consistency, synchronization status, and integrity verification results. Responsive to determining that the consensus validation condition has been satisfied, the identified network event is accepted for blockchain recording and collaborative propagation. Otherwise, the Detection Attestation Package is rejected or subjected to additional validation processing.

In an embodiment, performing the homomorphic similarity computation comprises maintaining the encrypted threat signature and the encrypted telemetry representations in encrypted form throughout generation of intermediate computational values associated with the similarity computation, repeatedly processing corresponding portions of the encrypted threat signature and the encrypted telemetry representations to generate encrypted partial similarity values, combining the encrypted partial similarity values into the encrypted similarity result, processing the encrypted similarity result to determine whether the similarity condition has been satisfied without reconstructing either the latent feature representation or the locally generated encrypted telemetry representations, and generating the encrypted corroboration information only after determination of the similarity condition. an embodiment, prior to similarity computation, the consensus validation unit establishes correspondence between encrypted computational segments of the encrypted threat signature and corresponding encrypted computational segments of each encrypted telemetry representation. Since both encrypted representations are generated using an identical feature transformation procedure and a common threshold homomorphic encryption context, corresponding encrypted computational segments remain positionally aligned, enabling comparison of equivalent encrypted feature positions without exposing the underlying numerical values.

The consensus validation unit subsequently performs homomorphic similarity computation by processing corresponding encrypted computational segments of the encrypted threat signature and the encrypted telemetry representation to generate encrypted partial similarity values. Rather than processing the encrypted representations as a single computational object, the consensus validation unit divides the similarity computation into multiple encrypted computational groups and independently processes each corresponding group to generate encrypted partial similarity values representing localized behavioural correspondence. The encrypted arithmetic operations preserve mathematical relationships among the encrypted feature values while maintaining the encrypted computational domain throughout the similarity computation.

Upon generation of the encrypted partial similarity values, the consensus validation unit combines the encrypted partial similarity values through encrypted aggregation operations to generate a unified encrypted similarity result. In one embodiment, the aggregation comprises encrypted weighted accumulation, encrypted averaging, encrypted normalization, or combinations thereof while maintaining confidentiality of intermediate computational values and preserving mathematical consistency throughout the aggregation process.

Following generation of the encrypted similarity result, the consensus validation unit determines whether a predefined similarity condition has been satisfied by performing a protected comparison between the encrypted similarity result and one or more encrypted threshold values without decrypting either the encrypted similarity result or the encrypted threshold values. The encrypted threshold values are established according to one or more of historical validation information, network operating conditions, attack propagation characteristics, and consensus configuration parameters. The protected comparison produces an encrypted decision indicating whether the similarity condition has been satisfied while preventing reconstruction of the encrypted threat signature, the encrypted telemetry representation, or the corresponding similarity value.

Throughout the similarity computation, encrypted arithmetic operations, intermediate computational values, aggregation results, and threshold comparison operations remain within the encrypted computational environment, thereby preventing disclosure of the originating network telemetry and the locally generated network telemetry while permitting collaborative behavioural comparison among participating network nodes.

Responsive to determining the similarity condition, the consensus validation unit generates encrypted corroboration information by combining the encrypted decision with validation metadata comprising validator identification information, blockchain synchronization parameters, computational timestamps, integrity verification information, and encrypted confidence information. The encrypted corroboration information is subsequently transmitted to the blockchain consensus mechanism for inclusion within a consolidated validation dataset together with encrypted corroboration information generated by other validator nodes participating in the same validation cycle, thereby supporting decentralized consensus while preserving confidentiality of the encrypted threat signature, encrypted telemetry representations, and intermediate computational results.

In an embodiment, recording the identified network event comprises generating a blockchain record containing the encrypted threat signature, the detection attestation package, the encrypted corroboration information and the updated reputation value, associating the blockchain record with the blockchain state reference corresponding to validation of the identified network event, storing the blockchain record in chronological association with previously validated network events, propagating the encrypted threat signature from the blockchain record to participating network nodes, receiving acknowledgement information corresponding to receipt of the encrypted threat signature by the participating network nodes, and updating the reputation value according to completion of propagation of the encrypted threat signature.

In an embodiment, upon determining by the consensus validation unit that a predetermined consensus validation condition has been satisfied, the blockchain record management unit generates a blockchain record corresponding to the validated network event. The blockchain record provides an immutable cryptographic record associating the validated network event with a distributed ledger while preserving integrity of computational artifacts generated during the collaborative validation process. Rather than storing original network telemetry, the blockchain record comprises cryptographically protected information generated during threat detection and collaborative validation, thereby permitting participating network nodes to verify authenticity and chronological occurrence of the validated network event without accessing confidential telemetry associated with an originating participating network node.

The blockchain record management unit constructs the blockchain record by incorporating an encrypted threat signature, a Detection Attestation Package (DAP), encrypted corroboration information, and an updated reputation value into a predefined verification structure. The encrypted threat signature represents encrypted characteristics associated with the validated network event. The Detection Attestation Package comprises a cryptographic commitment, authenticated identity information, intrusion detection model version information, blockchain integrity verification information, and metadata generated during creation of the encrypted threat signature. The encrypted corroboration information represents collaborative validation information independently generated by validating network nodes following encrypted similarity evaluation, while the updated reputation value represents a trust score associated with the originating participating network node following successful validation. The blockchain record management unit sequentially arranges the encrypted threat signature, the Detection Attestation Package, the encrypted corroboration information, and the updated reputation value together with field identifiers, data-length information, integrity markers, synchronization metadata, and cryptographic delimiters to generate a deterministic verification structure capable of identical reconstruction by participating blockchain nodes.

Following construction of the blockchain record, the blockchain record management unit associates the blockchain record with a blockchain state reference identifying the ledger state corresponding to successful completion of consensus validation. In one embodiment, the blockchain state reference comprises one or more of a validated block identifier, a block height, a transaction identifier, a ledger sequence number, a consensus epoch identifier, a timestamp value, a cryptographic hash of a previous blockchain block, or combinations thereof. Associating the blockchain record with the blockchain state reference establishes a cryptographic relationship between the validated network event and a corresponding blockchain transaction recorded within the distributed ledger.

The blockchain record management unit subsequently stores the blockchain record in chronological association with previously validated blockchain records maintained within the distributed ledger. The chronological ordering is determined according to blockchain timestamps, transaction ordering information, ledger sequence identifiers, and synchronization parameters such that validated network events are permanently maintained according to the sequence in which consensus validation is completed. The resulting chronological record enables subsequent retrieval and reconstruction of validated network events from the distributed ledger.

Following successful commitment of the blockchain record to the distributed ledger, the blockchain record management unit retrieves the encrypted threat signature from the committed blockchain record and propagates the encrypted threat signature to participating network nodes through authenticated communication sessions established among the participating blockchain nodes. Since the encrypted threat signature is retrieved directly from the committed blockchain record, every participating network node receives an identical cryptographically verified encrypted threat signature corresponding to the blockchain record permanently maintained within the distributed ledger.

Upon receiving the propagated encrypted threat signature, each participating network node verifies blockchain integrity information associated with the blockchain record before incorporating the propagated encrypted threat signature into a locally maintained blockchain ledger. Following successful verification, each participating network node generates acknowledgement information indicating successful receipt, verification, synchronization, and incorporation of the blockchain record. In one embodiment, the acknowledgement information comprises a participating node identifier, a transaction confirmation sequence, a synchronization timestamp, a ledger verification status, a cryptographic acknowledgement value, and a communication integrity indicator.

The blockchain record management unit receives acknowledgement information from the participating network nodes and evaluates synchronization status associated with intended recipients of the propagated encrypted threat signature. When acknowledgement information indicates incomplete synchronization, the blockchain record management unit selectively retransmits the encrypted threat signature to participating network nodes exhibiting delayed synchronization or communication interruption until predetermined propagation completion criteria have been satisfied.

Upon determining successful propagation of the encrypted threat signature, the blockchain record management unit updates the reputation value associated with the originating participating network node according to successful collaborative validation and propagation of the validated network event. In one embodiment, the updated reputation value is determined using one or more of historical validation success information, cumulative validated threat detections, propagation completion status, validator agreement information, synchronization consistency, and participation continuity maintained for previous consensus validation cycles. The updated reputation value is recorded in association with the originating participating network node within the distributed ledger and is subsequently utilized during validator selection, collaborative model update validation, consensus weighting, and distributed trust evaluation performed during subsequent consensus validation operations.

In an embodiment, processing the collaborative model updates comprises receiving the cryptographic commitments corresponding to proposed model updates from a plurality of participating network nodes, associating each proposed model update with the corresponding identity information and version information of the intrusion detection model, selectively exposing each proposed model update through authenticated secure communication established between hardware-attested trusted execution environments, generating encrypted validation information independently for respective proposed model updates, comparing the encrypted validation information corresponding to the proposed model updates before determination of acceptance, incorporating only accepted model updates into the collaborative model state according to the determination of acceptance, and recording the accepted model updates and rejected model updates as separate blockchain records associated with corresponding blockchain blocks.

In an embodiment, collaborative improvement of the intrusion detection capability is achieved through controlled validation of proposed model updates independently generated by participating network nodes. Each participating network node performs localized refinement of an intrusion detection model using network telemetry collected within its administrative domain, thereby retaining the network telemetry within the originating infrastructure. Rather than transmitting the refined intrusion detection model or the underlying network telemetry, the participating network node generates a proposed model update representing computational modifications to an existing collaborative model state. The proposed model update comprises one or more of parameter adjustment values, computational coefficients, feature transformation refinements, decision boundary modifications, or model refinement information generated following completion of one or more local training iterations.

Prior to transmission, a collaborative model update management unit generates a cryptographic commitment corresponding to the proposed model update by processing computational elements of the proposed model update together with associated metadata comprising update sequence information, local training iteration information, processing timestamps, and model configuration information. The resulting cryptographic commitment uniquely represents the proposed model update and enables subsequent integrity verification without revealing the computational contents of the proposed model update.

Following generation of the cryptographic commitment, the collaborative model update management unit associates the proposed model update with identity information corresponding to an authenticated execution environment and version information corresponding to the intrusion detection model used for generating the proposed model update. In one embodiment, the version information comprises one or more of model architecture identifiers, parameter configuration identifiers, feature transformation revision identifiers, processing configuration identifiers, update generation timestamps, and collaborative model sequence identifiers. Associating the identity information and version information with the proposed model update enables validator nodes to determine compatibility between the proposed model update and a collaborative intrusion detection model maintained by the participating network nodes while preserving traceability of the originating execution environment.

The collaborative model update management unit subsequently transmits the proposed model update to a plurality of validator nodes through authenticated communication sessions established exclusively between Trusted Execution Environments (TEEs). During establishment of the authenticated communication sessions, the Trusted Execution Environments exchange hardware-generated attestation information and mutually verify execution integrity, software configuration, and operational state before permitting transmission of the proposed model update. Upon successful authentication, the proposed model update is communicated directly between the Trusted Execution Environments while preventing access to the proposed model update by software executing outside the Trusted Execution Environments.

Upon receipt of the proposed model update, each validator node generates encrypted validation information by applying the proposed model update to a protected instance of the collaborative intrusion detection model maintained within the Trusted Execution Environment of the validator node. The validator node evaluates operational behaviour of the updated collaborative intrusion detection model using locally maintained validation telemetry and performs one or more verification procedures including assessment of detection consistency, behavioural stability, feature transformation continuity, convergence characteristics, computational efficiency, parameter coherence, and prediction consistency. Results generated during the verification procedures are encrypted to generate encrypted validation information while maintaining both the locally maintained validation telemetry and intermediate validation results within the Trusted Execution Environment.

Each validator node independently generates encrypted validation information using locally maintained validation datasets, thereby producing multiple encrypted validation records corresponding to a common proposed model update. The collaborative model update management unit receives the encrypted validation records from the validator nodes and maintains an association between each encrypted validation record and the validator node that generated the encrypted validation record.

Following receipt of the encrypted validation records, the collaborative model update management unit collectively evaluates the encrypted validation records to determine whether the proposed model update satisfies predetermined acceptance criteria. The evaluation comprises comparing validation outcomes generated by the validator nodes, determining a degree of agreement among the validator nodes, evaluating confidence distributions, analysing validation consistency, and detecting computational anomalies indicating unstable or potentially malicious model refinements. Proposed model updates satisfying the predetermined acceptance criteria are identified for incorporation into the collaborative model state, whereas proposed model updates failing to satisfy the predetermined acceptance criteria are identified for rejection.

Accepted proposed model updates are incorporated into the collaborative model state according to blockchain ordering maintained within the distributed ledger. The collaborative model update management unit sequentially merges computational parameters associated with accepted proposed model updates into the collaborative intrusion detection model according to corresponding blockchain transaction ordering, thereby maintaining an identical collaborative model state across participating network nodes.

For each accepted proposed model update and each rejected proposed model update, the collaborative model update management unit generates a corresponding blockchain record comprising the cryptographic commitment, identity information, version information, encrypted validation information, a validation decision, a blockchain state reference, and synchronization metadata corresponding to the collaborative learning cycle. The blockchain records are permanently associated with blockchain blocks according to the chronological order in which validation decisions are completed, thereby establishing an immutable historical record representing evolution of the collaborative intrusion detection model. The blockchain records enable subsequent verification of accepted and rejected model updates, reconstruction of collaborative model evolution, validation of model version consistency, and auditing of collaborative validation decisions while preserving confidentiality of locally maintained training telemetry and computational parameters.

In an embodiment, maintaining the verifiable model-state history comprises generating the model-state anchor immediately after incorporation of each accepted model update into the collaborative model state, generating a cryptographic hash representative of the collaborative model state after incorporation of the accepted model update, associating the cryptographic hash with a blockchain block corresponding to the accepted model update, generating a chained reference linking the generated model-state anchor with a preceding model-state anchor, storing the cryptographic hashes corresponding to the collaborative model state and the training-data commitments within the generated model-state anchor, and preserving chronological association between successive model-state anchors according to the blockchain blocks corresponding to the accepted model updates. n an embodiment, once a proposed model update has successfully completed decentralized validation and has been incorporated into the collaborative model state, the model-state history management unit generates a model-state anchor corresponding to the updated collaborative model state. Each model-state anchor provides an immutable reference representing the collaborative intrusion detection model immediately after incorporation of an accepted model update, thereby enabling every accepted refinement to be independently traceable throughout model evolution.

The model-state history management unit generates a cryptographic hash representing the updated collaborative model state, including model parameters, feature transformation configurations, behavioural representation mappings, computational coefficients, decision thresholds, and execution metadata. Since the collaborative model may comprise a large number of computational parameters, the complete model is processed through a cryptographic hashing procedure to generate a fixed-length cryptographic representation uniquely identifying the collaborative model state without recording the entire model within the distributed ledger.

The generated cryptographic hash is associated with the blockchain block corresponding to the accepted model update, thereby establishing a permanent relationship between the accepted collaborative model refinement and the blockchain transaction responsible for generating the updated collaborative model state. The association further records transaction identifiers, consensus information, timestamps, and synchronization metadata to enable subsequent identification of the blockchain transaction corresponding to the collaborative model state.

The model-state history management unit subsequently generates a chained reference linking the newly generated model-state anchor with a preceding model-state anchor maintained within the distributed ledger. Each newly generated model-state anchor incorporates a cryptographic reference to the immediately preceding model-state anchor, thereby establishing a continuous sequence of cryptographically linked collaborative model states in which modification of an earlier model-state anchor invalidates subsequent chained references.

Each model-state anchor further stores cryptographic commitments corresponding to training information associated with generation of the accepted model update. Rather than recording the underlying training telemetry, the model-state anchor stores cryptographic commitment values associated with the training information together with the cryptographic hash representing the updated collaborative model state, thereby establishing a verifiable association between the collaborative model state and the training information used for generating the accepted model update while preserving confidentiality of the underlying training telemetry.

In one embodiment, the model-state anchor additionally stores supplementary metadata including model version identifiers, collaborative learning iteration identifiers, update sequence identifiers, acceptance timestamps, validator consensus references, parameter revision identifiers, execution environment identifiers, and blockchain synchronization parameters to facilitate retrieval and verification of historical collaborative model states.

The model-state anchors are preserved according to blockchain ordering corresponding to accepted collaborative model updates, thereby maintaining an identical chronological model-state history across participating network nodes. During verification of a recorded network event, the model-state history management unit retrieves the corresponding model-state anchor, validates the chained references, verifies the stored cryptographic hash against the archived collaborative model state, confirms the associated training-data commitments, and reconstructs the computational lineage corresponding to the recorded network event.

Accordingly, the model-state history management unit establishes a cryptographically linked and chronologically ordered history of collaborative model evolution by generating model-state anchors for accepted collaborative model updates, associating the model-state anchors with corresponding blockchain transactions, linking successive model-state anchors through chained cryptographic references, recording cryptographic commitments corresponding to training information, and maintaining deterministic blockchain ordering for subsequent provenance verification and auditing.

In an embodiment, generating the cryptographic proof comprises identifying the blockchain record corresponding to the recorded network event, retrieving the model-state anchor associated with the identified blockchain record, retrieving the hardware attestation associated with the detection attestation package corresponding to the recorded network event, generating proof data representing association of the recorded network event with the blockchain record, the model-state anchor and the hardware attestation, verifying consistency among the blockchain record, the model-state anchor and the hardware attestation before generation of the cryptographic proof, and providing the generated cryptographic proof without exposing the network telemetry, the latent feature representation, the encrypted telemetry representations or the collaborative model state.

Initially, the cryptographic proof generation unit identifies the blockchain record corresponding to the recorded network event by querying the distributed blockchain ledger using one or more event identification parameters included within the verification request. The identification parameters may comprise a blockchain transaction identifier, event identifier, blockchain block number, consensus timestamp, detection attestation identifier, validator reference identifier, or any combination thereof capable of uniquely locating the required blockchain record. The blockchain record contains the immutable evidence generated during the original consensus validation process, including the encrypted threat signature, detection attestation package, encrypted corroboration information, blockchain state reference, integrity verification values, and reputation information associated with the validated network event. As an illustrative example, a verification request referencing blockchain transaction identifier “Block-1258437: Tx-0148” enables the cryptographic proof generation unit to retrieve the precise blockchain record corresponding to a validated threat detection event without scanning unrelated blockchain transactions, thereby significantly reducing computational retrieval time even when the blockchain ledger contains millions of historical records.

Following identification of the blockchain record, the cryptographic proof generation unit retrieves the model-state anchor associated with the identified blockchain record. Since every accepted collaborative model update generates a corresponding model-state anchor that is permanently linked to the blockchain block in which the update was accepted, the retrieved model-state anchor uniquely represents the computational configuration of the collaborative intrusion detection model responsible for generating the recorded network event. The retrieved model-state anchor includes the cryptographic hash corresponding to the collaborative model state, chained references linking the anchor to preceding model-state anchors, cryptographic commitments corresponding to the training information used during collaborative model refinement, blockchain association parameters, and additional verification metadata. Retrieval of the model-state anchor therefore enables reconstruction of the authenticated computational lineage existing when the threat detection occurred without requiring storage or transmission of the complete collaborative model itself. For instance, where the collaborative intrusion detection model has evolved through approximately 8,500 accepted model updates over several months of operation, the blockchain record directly identifies the specific model-state anchor corresponding to the model revision responsible for the validated threat detection, thereby eliminating the need to reconstruct every intermediate collaborative learning iteration.

Subsequently, the cryptographic proof generation unit retrieves the hardware attestation associated with the detection attestation package corresponding to the recorded network event. The hardware attestation represents authenticated evidence generated by the hardware-attested trusted execution environment during execution of the intrusion detection model. The hardware attestation confirms that the threat detection process was executed within an authenticated isolated execution environment, that the executable program instructions remained unmodified during processing, that the processing memory maintained integrity throughout execution, and that the model identity together with the corresponding version information matched an authorized computational configuration at the time the network event was identified. In one implementation, the hardware attestation may comprise an execution environment identifier, processor measurement values, execution integrity measurements, authenticated software configuration identifiers, secure boot verification parameters, memory protection measurements, and digitally signed authentication information. As an illustrative example, a hardware attestation generated during execution of intrusion detection model version 6.1.3 may contain a unique execution environment identifier together with integrity measurements representing the verified execution context existing at the precise moment the encrypted threat signature was generated. Retrieval of this hardware attestation enables subsequent verification that the recorded network event originated from an authenticated processing environment rather than from an unauthorized or modified execution platform.

After retrieving the blockchain record, the corresponding model-state anchor, and the associated hardware attestation, the cryptographic proof generation unit generates proof data representing the computational association among these independently maintained evidence sources. The proof data is not merely a collection of retrieved records but instead represents a cryptographically linked verification structure demonstrating that the recorded network event, the blockchain record, the collaborative model state, and the authenticated execution environment collectively correspond to a single validated detection process. Generation of the proof data involves extracting cryptographic identifiers from each retrieved evidence source, establishing deterministic relationships among the identifiers, arranging the identifiers according to a predefined computational sequence, and generating a composite verification structure linking every component through cryptographic references. For example, the proof data may include the blockchain transaction identifier obtained from the blockchain record, the cryptographic hash representing the collaborative model state extracted from the model-state anchor, the authenticated execution environment identifier extracted from the hardware attestation, and integrity verification values derived from the original detection attestation package. These parameters are computationally associated to demonstrate that the recorded network event was detected using a specific authenticated model state executing within a verified execution environment and permanently recorded within a corresponding blockchain transaction.

Before generation of the final cryptographic proof, the cryptographic proof generation unit performs comprehensive consistency verification among the blockchain record, the retrieved model-state anchor, and the hardware attestation to ensure that all evidence sources describe the same authenticated detection event. During consistency verification, blockchain association parameters maintained within the model-state anchor are compared with blockchain references stored in the blockchain record, model version information maintained within the hardware attestation is compared with version information contained in the detection attestation package, identity information associated with the authenticated execution environment is verified against the execution identifiers referenced within the blockchain record, and integrity verification values are recalculated to confirm that no unauthorized modification has occurred since the original threat detection was recorded. As an illustrative example, the cryptographic proof generation unit may verify that the blockchain record references block number 1,258,437, that the retrieved model-state anchor was generated immediately following acceptance of the collaborative model update associated with the same blockchain block, and that the hardware attestation confirms execution of the corresponding model version identified within the detection attestation package. If any inconsistency is detected, such as mismatch between model version identifiers, absence of the referenced model-state anchor, alteration of blockchain integrity values, or inconsistency between execution environment identifiers, generation of the cryptographic proof is terminated and the verification request is rejected until the inconsistency is resolved. This verification procedure prevents generation of misleading or incomplete cryptographic evidence and ensures that only internally consistent computational records contribute to the final proof.

Following successful consistency verification, the cryptographic proof generation unit generates the cryptographic proof by processing the verified proof data through a cryptographic transformation procedure that produces a compact verification object uniquely representing the authenticated relationship among the blockchain record, model-state anchor, and hardware attestation. The resulting cryptographic proof may include one or more digitally verifiable cryptographic values together with associated verification metadata enabling independent verification by authorized computing entities. For example, a verification object occupying approximately 2 to 4 kilobytes may contain cryptographic references to the blockchain transaction, authenticated execution environment, collaborative model state identifier, integrity verification values, chained model-state references, and digitally generated proof values capable of being independently validated using publicly available blockchain information together with authorized verification credentials. Since the proof is generated exclusively from authenticated evidence already maintained within the decentralized cybersecurity framework, the verifier need not access confidential operational datasets or proprietary model parameters to establish the legitimacy of the recorded network event.

The generated cryptographic proof is subsequently provided to the requesting computing entity while ensuring that confidential information associated with the original detection process remains protected. More specifically, the cryptographic proof is generated without exposing the original network telemetry collected from the participating network node, the latent feature representation generated by the intrusion detection model, the encrypted telemetry representations independently generated by validator nodes, or the collaborative model state maintained within the decentralized learning framework. Instead, the proof demonstrates that these confidential computational artifacts existed, were processed within authenticated execution environments, participated in decentralized consensus validation, and resulted in the validated blockchain record, without revealing the contents of the artifacts themselves. For instance, an external auditing authority verifying compliance with cybersecurity regulations can independently confirm that a reported intrusion detection event originated from an authenticated collaborative model executing within a protected execution environment and was validated through decentralized blockchain consensus, while remaining completely unaware of the originating organization's network topology, communication behaviour, attack signatures, telemetry contents, feature representations, or collaborative model parameters.

In one practical implementation, the cryptographic proof may be generated within approximately 300 to 800 milliseconds for blockchain records containing historical events recorded several months earlier, thereby enabling efficient forensic verification even within large-scale decentralized deployments maintaining millions of validated network events. Because the verification process relies exclusively upon immutable blockchain records, authenticated model-state anchors, and hardware-generated execution attestations rather than confidential operational data, the generated proof remains reproducible throughout the operational lifetime of the decentralized cybersecurity system. This implementation establishes a reliable mechanism for demonstrating authenticity, integrity, provenance, and execution legitimacy of historical cyber threat detection events while simultaneously preserving confidentiality of sensitive network telemetry, computational feature representations, collaborative learning parameters, and organization-specific security information that would otherwise be exposed during conventional forensic verification procedures.

In an embodiment, generating the latent feature representation comprises sequentially processing feature values extracted from the network telemetry to generate intermediate feature groups representative of communication behaviour associated with the identified network event, maintaining positional correspondence between the intermediate feature groups and respective portions of the network telemetry during generation of the latent feature representation, generating the latent feature representation from the intermediate feature groups without storing the intermediate feature groups within the blockchain record, and retaining the latent feature representation within the hardware-attested trusted execution environment until completion of generation of the encrypted threat signature.

In an embodiment, generation of the latent feature representation is performed as a progressive computational transformation process that converts processed network telemetry into a compact behavioural representation while preserving the intrinsic relationships among communication characteristics associated with the identified network event. Following preprocessing and normalization of the network telemetry, the telemetry processing unit receives a plurality of feature values extracted from communication sessions corresponding to the participating network node. The extracted feature values represent quantifiable communication characteristics derived from the observed network activity and may include communication frequency, session persistence, packet transmission intervals, packet size distributions, bidirectional traffic ratios, authentication sequences, protocol transition patterns, resource access frequencies, communication timing variations, connection establishment durations, retransmission characteristics, process interaction frequencies, and network flow continuity measurements. Instead of processing all extracted feature values simultaneously, the telemetry processing unit sequentially processes the feature values in multiple computational stages so that behavioural dependencies existing among successive communication attributes are progressively identified and preserved. For example, a monitoring interval of ten seconds may produce approximately 40,000 telemetry records from which nearly 320 normalized feature values are extracted for each communication session. These feature values are sequentially processed in groups of 32 feature values during ten successive computational iterations, thereby enabling efficient utilization of processing resources while preserving temporal relationships among the extracted communication characteristics.

During sequential processing, the telemetry processing unit generates a plurality of intermediate feature groups representative of communication behaviour associated with the identified network event. Each intermediate feature group represents a collection of related behavioural descriptors generated from corresponding subsets of the extracted feature values rather than isolated numerical measurements. The telemetry processing unit evaluates statistical relationships, temporal continuity, communication directionality, interaction frequency, and behavioural dependencies existing among neighbouring feature values to produce computationally meaningful intermediate feature groups that collectively characterize the observed communication behaviour. As an illustrative example, one intermediate feature group may represent authentication behaviour by combining authentication request intervals, credential verification outcomes, session establishment timing, and privilege assignment characteristics into a unified behavioural descriptor, while another intermediate feature group may represent communication persistence by integrating packet transmission frequency, session duration, idle intervals, and connection termination characteristics. In one implementation, approximately 320 extracted feature values may be transformed into forty intermediate feature groups, each intermediate feature group containing eight aggregated behavioural descriptors that collectively represent a distinct aspect of the observed network activity.

In an embodiment, encrypting the latent feature representation comprises partitioning the latent feature representation into a plurality of encrypted computational segments, generating encrypted values corresponding to the computational segments using a common threshold encryption context, associating the encrypted computational segments to preserve positional correspondence existing in the latent feature representation, and generating the encrypted threat signature from the associated encrypted computational segments without reconstructing the latent feature representation following encryption.

In an embodiment, after completion of generation of the latent feature representation within the hardware-attested trusted execution environment, the detection attestation generation unit initiates an encryption procedure to transform the latent feature representation into a cryptographically protected representation suitable for decentralized validation. The latent feature representation comprises a multidimensional numerical structure that encapsulates behavioural characteristics extracted from the processed network telemetry while eliminating redundant communication information. Since the latent feature representation itself may indirectly reveal behavioural patterns associated with the originating network activity, the present embodiment performs encryption before any information leaves the trusted execution environment. Consequently, the behavioural characteristics represented by the latent feature representation remain inaccessible to external computing entities while still enabling subsequent collaborative similarity evaluation among participating network nodes. For example, a latent feature representation consisting of 256 numerical feature values generated from approximately 60,000 processed telemetry records may occupy nearly 2 kilobytes in memory prior to encryption, whereas the resulting encrypted representation can be securely transmitted to validator nodes without exposing any recoverable communication characteristics associated with the originating network event.

Initially, the detection attestation generation unit partitions the latent feature representation into a plurality of encrypted computational segments to facilitate efficient cryptographic processing and parallel computation. Rather than encrypting the complete latent feature representation as a single computational object, the numerical feature values are divided into multiple computational segments according to predetermined segmentation criteria while preserving the logical continuity of neighbouring behavioural characteristics. The segmentation process may be performed according to feature position, computational dimension, behavioural grouping, or predefined segment size depending upon implementation requirements. For instance, a latent feature representation containing 256 numerical feature values may be partitioned into sixteen computational segments, each computational segment containing sixteen consecutive feature values. In another implementation, a 128-dimensional latent feature representation may be divided into eight computational segments of equal length, whereas larger feature representations containing 512 feature values may be partitioned into thirty-two computational segments to improve scalability of subsequent cryptographic processing. Dividing the latent feature representation into computational segments enables independent processing of individual segments, reduces computational memory requirements during encryption, and allows simultaneous execution of encryption operations across multiple processor cores operating within the trusted execution environment.

Following segmentation, the detection attestation generation unit generates encrypted values corresponding to each computational segment using a common threshold encryption context established for participating network nodes. The threshold encryption context represents a shared cryptographic framework defining the mathematical parameters, encryption keys, computational precision, modulus values, polynomial dimensions, and security parameters employed during encrypted computation. Because every participating network node utilizes the identical threshold encryption context, encrypted computational segments generated independently by geographically distributed organizations remain mutually compatible for subsequent homomorphic similarity evaluation. During encryption, each computational segment is individually processed using the common threshold encryption context to generate a corresponding encrypted value while maintaining complete confidentiality of the underlying numerical feature values. For example, sixteen computational segments generated from a latent feature representation may produce sixteen corresponding encrypted values, each encrypted value representing a cryptographically protected version of the original computational segment without disclosing the contained behavioural information. Even if two computational segments contain similar numerical values, the generated encrypted values remain computationally protected and cannot be interpreted without satisfying the predefined threshold decryption requirements established by the collaborative cybersecurity framework.

The common threshold encryption context additionally ensures that every encrypted computational segment generated throughout the decentralized network conforms to identical computational characteristics, thereby enabling interoperable encrypted processing among independently operating validator nodes. More specifically, participating network nodes employ identical cryptographic parameter configurations including encryption precision, computational scaling factors, ciphertext representation formats, key generation parameters, and encrypted arithmetic capabilities. As an illustrative example, the threshold encryption context may be configured to support encrypted representations accommodating numerical values within a normalized range of −1.0 to +1.0 while preserving computational precision up to six decimal places during encrypted arithmetic operations. Since identical cryptographic parameters are applied across all participating organizations, encrypted computational segments generated from behaviourally similar network events can subsequently participate in encrypted similarity computations without requiring format conversion, parameter adjustment, or intermediate decryption. This common cryptographic framework substantially improves computational interoperability while preserving strict confidentiality of behavioural information represented within the encrypted values.

After generation of the encrypted values corresponding to the respective computational segments, the detection attestation generation unit associates the encrypted computational segments in a manner that preserves the positional correspondence existing within the original latent feature representation. Positional correspondence refers to the maintenance of the original logical ordering and semantic relationship among the feature values following encryption. During segmentation, every computational segment retains metadata identifying its original position within the latent feature representation, including segment sequence identifiers, positional offsets, dimensional indices, and neighbouring segment references. When the encrypted values are subsequently associated to construct the encrypted representation, these positional identifiers ensure that the encrypted computational segments occupy positions corresponding exactly to their respective locations within the original latent feature representation. For example, if computational segment three originally represented communication timing characteristics corresponding to feature positions 33 through 48, the encrypted value generated from computational segment three remains associated with the identical positional interval following encryption. Likewise, encrypted computational segment eight corresponding to authentication behaviour continues to occupy its designated logical position relative to neighbouring encrypted computational segments. Preservation of positional correspondence enables subsequent validator nodes to compare equivalent behavioural characteristics directly during homomorphic similarity computation without requiring reconstruction of the plaintext latent feature representation.

The association process further generates an ordered encrypted computational structure wherein every encrypted computational segment is sequentially arranged according to its original positional relationship. The ordered structure may include segment identifiers, encrypted segment length indicators, computational offsets, integrity verification parameters, and structural delimiters facilitating deterministic interpretation of the encrypted representation by participating validator nodes. For example, an ordered encrypted structure containing sixteen encrypted computational segments may include a segment header specifying the segment sequence number, followed by the encrypted computational value, segment length information, positional offset parameters, and continuation identifiers linking adjacent encrypted computational segments. Such deterministic organization enables every validator node receiving the encrypted representation to establish correspondence among equivalent encrypted feature regions during subsequent similarity computation while eliminating ambiguity associated with segment ordering or feature alignment. Following completion of the association process, the detection attestation generation unit generates the encrypted threat signature directly from the associated encrypted computational segments without reconstructing the latent feature representation after encryption. More specifically, the encrypted threat signature is formed by combining the ordered encrypted computational segments together with associated structural metadata into a unified cryptographic representation suitable for transmission to the decentralized blockchain network. Since the encrypted computational segments already preserve every positional and behavioural relationship required for subsequent encrypted processing, reconstruction of the original latent feature representation becomes unnecessary following completion of encryption. Eliminating post-encryption reconstruction substantially reduces the possibility of exposing plaintext behavioural information outside the protected execution environment while minimizing computational overhead associated with repeated transformation between encrypted and plaintext representations. As an illustrative example, after generation of sixteen encrypted computational segments, the detection attestation generation unit assembles the encrypted threat signature by incorporating encrypted segment identifiers, encrypted computational values, positional correspondence information, and integrity metadata into a single encrypted representation occupying approximately 6 kilobytes. Throughout this process, the plaintext latent feature representation remains confined within protected memory and is not regenerated following encryption.

Upon successful generation of the encrypted threat signature, the trusted execution environment releases only the encrypted threat signature together with the corresponding cryptographic metadata for inclusion within the detection attestation package, while the plaintext latent feature representation is retained within protected memory only for the duration necessary to complete the encryption process. Following successful verification that the encrypted threat signature has been generated correctly, the temporary memory locations containing the plaintext latent feature representation are securely overwritten or released according to protected memory management procedures implemented by the trusted execution environment. For example, memory pages containing the 256-dimensional latent feature representation may be cleared immediately after successful generation of the encrypted threat signature by replacing every stored numerical value with predetermined overwrite patterns before releasing the protected memory for subsequent computational tasks. This controlled memory management process minimizes residual exposure of sensitive behavioural information and reduces the possibility of unauthorized recovery of latent feature representations through memory inspection or forensic analysis.

By partitioning the latent feature representation into computationally manageable encrypted segments, generating encrypted values using a common threshold encryption context, preserving positional correspondence throughout encryption, assembling the encrypted threat signature directly from the associated encrypted computational segments, and avoiding reconstruction of the plaintext latent feature representation after encryption, the present embodiment establishes a highly secure transformation mechanism that supports efficient decentralized similarity computation while maintaining strict confidentiality of behavioural representations derived from the originating network telemetry.

In an embodiment, generating the detection attestation package further comprises generating a cryptographic integrity value over the encrypted threat signature, the cryptographic commitment, the identity information, the version information and the blockchain state reference in a predetermined sequence, storing the cryptographic integrity value within the detection attestation package, and validating the cryptographic integrity value before processing the detection attestation package for consensus validation.

In an embodiment, after generation of the encrypted threat signature and before transmission of the detection attestation package to the blockchain network, the detection attestation generation unit generates a cryptographic integrity value configured to provide end-to-end verification of the complete detection attestation package. Rather than independently validating individual elements contained within the package, the present embodiment generates a unified integrity value representing the collective computational state of the encrypted threat signature, the cryptographic commitment, the identity information, the version information, and the blockchain state reference. This unified integrity value enables participating validator nodes to determine whether any portion of the detection attestation package has been altered during temporary storage, communication, synchronization, or blockchain dissemination. Since the integrity value is generated only after every constituent element has been finalized, it accurately reflects the exact computational contents of the detection attestation package at the time of creation. For example, a detection attestation package containing an encrypted threat signature of approximately 8 kilobytes, a 256-bit cryptographic commitment, authenticated execution identifiers, model version information, and blockchain synchronization metadata may generate a single fixed-length integrity value occupying only a few hundred bits while uniquely representing the entire package contents.

The cryptographic integrity value is generated by sequentially processing the constituent elements according to a predetermined computational sequence that remains identical across all participating network nodes. The predetermined sequence defines not only the order in which the elements are processed but also the structural boundaries separating adjacent elements, thereby ensuring deterministic generation of the integrity value irrespective of the originating network node. In one implementation, the encrypted threat signature is processed first because it represents the primary behavioural evidence associated with the detected network event. The cryptographic commitment corresponding to the processed network telemetry is processed immediately thereafter, followed by the authenticated identity information identifying the trusted execution environment responsible for generating the detection result. Subsequently, the version information corresponding to the intrusion detection model is incorporated, after which the blockchain state reference identifying the current blockchain synchronization state is appended to complete the ordered computational sequence. As an illustrative example, if two participating network nodes independently generate identical encrypted threat signatures and associated metadata corresponding to equivalent network events, adherence to the identical predetermined sequence ensures that both nodes produce identical integrity values, thereby enabling deterministic verification during decentralized consensus processing.

During generation of the integrity value, the detection attestation generation unit first serializes each constituent element into a standardized computational representation while preserving its structural boundaries. Variable-length data structures such as the encrypted threat signature are preceded by length indicators, whereas fixed-length parameters including cryptographic commitments, version identifiers, and blockchain references are arranged according to predefined positional offsets. Delimiter values, sequence identifiers, and structural markers may additionally be inserted between adjacent computational elements to prevent ambiguity during reconstruction of the ordered sequence. For example, an encrypted threat signature occupying 8,192 bytes may be preceded by a four-byte length identifier, followed by a delimiter separating the encrypted threat signature from the subsequent 256-bit cryptographic commitment. The authenticated identity information may then occupy a predetermined 128-byte section, followed by a fixed-length version descriptor and a blockchain state reference comprising a block identifier, transaction sequence identifier, and synchronization timestamp. This deterministic serialization process ensures that identical computational structures are generated whenever identical constituent elements are processed.

Once the standardized computational sequence has been assembled, the complete ordered representation is processed through a cryptographic transformation procedure configured to generate the cryptographic integrity value. The transformation procedure sequentially evaluates every byte contained within the ordered representation so that the resulting integrity value becomes mathematically dependent upon every constituent element of the detection attestation package. Consequently, modification of any individual parameter, irrespective of its size or position within the package, results in generation of a substantially different integrity value. As an illustrative example, altering a single encrypted computational segment within the encrypted threat signature, modifying one bit of the cryptographic commitment, replacing the authenticated execution identifier, changing the intrusion detection model version from revision 5.2.3 to revision 5.2.4, or updating the blockchain state reference to an adjacent block identifier all produce completely different integrity values despite the remainder of the package remaining unchanged. This computational sensitivity enables reliable detection of accidental corruption, transmission errors, unauthorized modification, or malicious substitution affecting any constituent element contained within the detection attestation package.

Following successful generation of the cryptographic integrity value, the detection attestation generation unit stores the generated integrity value directly within the detection attestation package together with the associated computational elements. The integrity value is maintained as an independent verification field positioned according to a predefined package format so that every validator node can readily identify and retrieve the stored integrity value during subsequent validation. In one implementation, the detection attestation package comprises a package header, the encrypted threat signature, the cryptographic commitment, authenticated identity information, version information, blockchain state reference, integrity verification field, and additional synchronization metadata. The integrity verification field contains only the generated cryptographic integrity value and remains permanently associated with the remaining package contents throughout transmission, temporary buffering, blockchain recording, and validator processing. As an illustrative example, a detection attestation package having an overall size of approximately 9 kilobytes may reserve a dedicated 256-bit integrity verification field positioned immediately before the package trailer, thereby enabling efficient extraction of the integrity value during validator-side verification without requiring reconstruction of unrelated package components.

Before the detection attestation package is accepted for decentralized consensus validation, the consensus validation unit performs independent validation of the stored cryptographic integrity value to confirm that the received package remains identical to the originally generated package. Upon receipt of the detection attestation package, each validator node reconstructs the predetermined computational sequence by extracting the encrypted threat signature, cryptographic commitment, identity information, version information, and blockchain state reference according to the predefined package structure. The validator node subsequently regenerates an independent integrity value by processing the reconstructed computational sequence using the same cryptographic transformation procedure employed during package generation. The regenerated integrity value is then compared with the stored integrity value extracted from the integrity verification field. Matching integrity values confirm that every constituent element contained within the received detection attestation package remains identical to the originally generated package. Conversely, any discrepancy between the regenerated integrity value and the stored integrity value immediately indicates that one or more computational elements have been modified, corrupted, reordered, truncated, or substituted after generation of the original package. For example, assume that the encrypted threat signature is correctly received by all validator nodes, but an unintended communication error modifies a single bit within the blockchain state reference during transmission to one validator node. Although the modification affects only a single computational element occupying a few bytes, regeneration of the integrity value from the received package produces a verification result entirely different from the integrity value stored within the detection attestation package. The affected validator node therefore rejects the detection attestation package before initiating homomorphic similarity computation or consensus evaluation, thereby avoiding unnecessary computational processing of corrupted evidence. Similarly, if an unauthorized entity attempts to substitute an alternative intrusion detection model version or modify the authenticated identity information while preserving the encrypted threat signature, the regenerated integrity value fails to match the stored integrity value, immediately exposing the unauthorized modification and preventing participation of the altered package in the decentralized validation workflow.

Only after successful validation of the cryptographic integrity value does the consensus validation unit permit further processing of the detection attestation package for decentralized consensus validation. Successful integrity verification confirms that the encrypted threat signature, the associated cryptographic commitment, the authenticated execution information, the intrusion detection model version, and the blockchain synchronization state collectively remain unchanged since generation of the original package. Consequently, every validator node participating in the collaborative cybersecurity framework performs homomorphic similarity computation and consensus evaluation using computationally identical threat intelligence derived from the originating trusted execution environment. This implementation significantly strengthens the reliability of decentralized validation by preventing corrupted or manipulated detection evidence from influencing blockchain consensus, minimizing unnecessary computational expenditure associated with processing invalid packages, preserving synchronization consistency among geographically distributed validator nodes, and establishing a deterministic verification mechanism that continuously safeguards the authenticity and integrity of every detection attestation package throughout its operational lifecycle.

In an embodiment, processing the detection attestation package further comprises independently processing the encrypted threat signature against respective encrypted telemetry representations received from the selected validator nodes, generating individual encrypted similarity results corresponding to the respective encrypted telemetry representations, arranging the encrypted similarity results into a consolidated validation structure preserving validator-specific correspondence, and determining the consensus validation condition using the consolidated validation structure.

In an embodiment, after successful verification of the integrity of the detection attestation package, the consensus validation unit initiates a distributed similarity evaluation procedure in which the encrypted threat signature is independently processed against the encrypted telemetry representations generated by each of the selected validator nodes. Rather than collectively evaluating all validator responses as a single computational entity, the present embodiment treats every validator node as an independent source of validation evidence, thereby allowing the behavioural correspondence between the originating network event and the locally observed communication behaviour of each participating validator node to be assessed separately. This independent processing architecture minimizes the possibility that abnormal telemetry originating from one validator node influences the similarity determination of another validator node while simultaneously enabling the decentralized cybersecurity framework to evaluate geographically distributed attack manifestations individually. For example, where fifteen validator nodes participate in a consensus round, fifteen independent encrypted telemetry representations are received, each corresponding to communication activities observed within separate organizational environments. Each encrypted telemetry representation therefore reflects local behavioural characteristics unique to the respective validator node while remaining fully compatible with the encrypted threat signature through the common feature transformation and threshold encryption context.

Upon receipt of the encrypted telemetry representations, the consensus validation unit allocates a dedicated computational context to each validator node so that similarity evaluation proceeds independently without interaction among the encrypted datasets received from different validators. Every computational context retrieves the encrypted threat signature from the validated detection attestation package and associates it exclusively with the encrypted telemetry representation corresponding to a particular validator node. The encrypted telemetry representations remain logically isolated throughout processing, thereby preventing intermediate computational values generated for one validator node from influencing similarity calculations performed for another validator node. As an illustrative example, if twelve encrypted telemetry representations are available, the consensus validation unit establishes twelve independent processing instances, each instance sequentially receiving one encrypted telemetry representation together with the common encrypted threat signature. The processing instances may execute concurrently across multiple processor cores, allowing simultaneous similarity evaluation while maintaining complete computational independence among validator-specific processing environments.

In an embodiment, generating the encrypted corroboration information comprises generating validator-specific encrypted corroboration values corresponding to the encrypted similarity results, associating each encrypted corroboration value with the blockchain state reference corresponding to the received detection attestation package, combining the validator-specific encrypted corroboration values into a collective corroboration record, and processing the collective corroboration record during determination of the consensus validation condition.

In an embodiment, after completion of validator-specific similarity evaluation, the consensus validation unit initiates generation of encrypted corroboration information representing the independent validation outcome produced by each participating validator node. The encrypted corroboration information functions as cryptographically protected validation evidence indicating whether the communication behaviour locally observed by an individual validator node sufficiently corresponds to the behavioural characteristics represented by the received encrypted threat signature. Instead of transmitting intermediate similarity values or validator-specific telemetry to the blockchain network, each validator node generates an encrypted corroboration value that encapsulates only the validation outcome together with associated computational metadata. Consequently, the decentralized validation framework exchanges only the minimum amount of information required for consensus determination while ensuring that organization-specific communication characteristics remain confined within the originating validator environment. For example, where twenty validator nodes participate in a validation cycle, twenty independent encrypted corroboration values are generated, each representing the locally observed behavioural correspondence without revealing the underlying encrypted telemetry representation, feature distributions, or numerical similarity measurements that produced the corresponding validation outcome.

In an embodiment, updating the reputation value comprises identifying previously validated network events associated with the participating network node, determining a cumulative validation history from the previously validated network events and the identified network event, generating an updated reputation value according to the cumulative validation history, associating the updated reputation value with the participating network node within the blockchain record, and retrieving the updated reputation value during subsequent validator selection and collaborative model update processing.

Initially, the reputation management unit identifies previously validated network events associated with the participating network node by querying blockchain records that maintain a permanent association between validated threat detections and the originating node identifier. Since every successfully validated network event is immutably recorded together with the corresponding authenticated identity information, blockchain state reference, consensus outcome, and propagation status, the reputation management unit retrieves the complete operational history without relying on externally maintained databases. The retrieved historical information may include the total number of validated detections, validation timestamps, validator agreement levels, successful propagation records, historical reputation values, consensus completion intervals, collaborative model update participation, and previous validator assignments. For example, a participating network node operating continuously for approximately eighteen months may have generated nearly 2,800 validated network events distributed across more than 40,000 blockchain blocks. The reputation management unit retrieves these authenticated historical records through indexed blockchain queries, enabling efficient reconstruction of the node's validation history even within blockchain ledgers containing millions of recorded cybersecurity events.

Following identification of the historical blockchain records, the reputation management unit determines a cumulative validation history by combining information associated with the previously validated network events together with the newly identified network event that has just completed decentralized consensus validation. Rather than evaluating the newly validated event in isolation, the cumulative validation history reflects the long-term operational behaviour of the participating network node across multiple consensus cycles. The cumulative validation history may incorporate parameters including historical validation acceptance frequency, consistency of validator corroboration, successful completion of encrypted threat signature propagation, participation continuity, historical contribution to collaborative model refinement, responsiveness during previous validation cycles, synchronization consistency with the blockchain network, and chronological distribution of validated detections. As an illustrative example, if a participating network node previously generated 425 validated network events with an average validator agreement equivalent to approximately 94%, and the newly validated event receives corroboration from 23 of 25 participating validator nodes, the cumulative validation history reflects both the established historical consistency and the successful outcome of the most recent decentralized validation. Conversely, where a participating node exhibits prolonged inactivity followed by isolated validation success, the cumulative validation history naturally reflects the comparatively limited operational contribution over the evaluation period.

In certain implementations, the cumulative validation history may additionally account for the temporal distribution of validated network events so that recent operational performance contributes more significantly to the updated reputation value than substantially older validation records. The reputation management unit therefore evaluates the chronological continuity of successful validations by considering the relative age of historical blockchain records together with the consistency of ongoing participation. For example, assume that one participating network node successfully validated 1,000 network events within the previous three months, whereas another node generated an equivalent number of validated events nearly two years earlier but has since exhibited minimal collaborative participation. Although both nodes possess similar cumulative validation counts, the reputation management unit may assign greater computational significance to the more recent validation activity because it better reflects the current operational behaviour and synchronization status of the participating network node. Such temporal evaluation enables the decentralized cybersecurity framework to adapt reputation values according to evolving participation patterns without disregarding authenticated historical contributions permanently preserved within the blockchain ledger.

After determining the cumulative validation history, the reputation management unit generates an updated reputation value corresponding to the participating network node. Generation of the updated reputation value involves computational evaluation of the cumulative validation history to produce a normalized numerical representation indicative of the node's demonstrated reliability within the decentralized consensus framework. Rather than applying fixed incremental adjustments following every validated event, the updated reputation value reflects multiple operational characteristics observed throughout the cumulative validation history, including consistency of successful detections, agreement achieved during validator corroboration, reliability of collaborative model update contributions, completion of encrypted threat signature propagation, blockchain synchronization stability, participation continuity, and historical responsiveness during decentralized validation procedures. As an illustrative example, a participating network node maintaining a previous normalized reputation value of 0.84 may receive an updated reputation value of approximately 0.89 following successful validation of a high-confidence threat detection corroborated by 96% of participating validator nodes together with uninterrupted participation during recent collaborative learning cycles. Conversely, another node maintaining the same initial reputation value but exhibiting inconsistent validator agreement and intermittent synchronization interruptions may receive only a marginal adjustment to approximately 0.85 despite successful validation of the most recent network event. This adaptive computation ensures that reputation evolution reflects sustained operational quality rather than isolated validation successes.

The generated updated reputation value is thereafter associated with the participating network node within the blockchain record corresponding to the validated network event. Instead of maintaining reputation information within separate centralized trust repositories, the updated reputation value becomes an integral component of the immutable blockchain record generated during recording of the validated network event. The blockchain record therefore permanently associates the participating node identifier, validated detection information, consensus outcome, encrypted corroboration information, blockchain state reference, and updated reputation value within a single authenticated evidence structure. As an illustrative example, blockchain block number 1,652,430 may contain a blockchain record indicating that participating network node PN-042 successfully generated a validated threat detection, completed decentralized propagation, and received an updated reputation value of 0.91 following evaluation of its cumulative validation history. Because the updated reputation value is permanently recorded together with the corresponding blockchain transaction, any subsequent verification procedure can independently confirm both the origin of the reputation adjustment and the authenticated operational evidence supporting the adjustment without reliance on external administrative records.

The association process further enables reconstruction of the complete evolution of the reputation value over time. Since every reputation update is recorded within successive blockchain records, the reputation management unit can retrieve historical reputation values corresponding to earlier blockchain blocks and determine how operational behaviour has influenced trust evolution throughout the lifecycle of the participating network node. For example, a participating network node may initially possess a normalized reputation value of 0.52 upon joining the collaborative cybersecurity framework. After approximately 300 successfully validated threat detections, the recorded blockchain history may demonstrate progressive increases to 0.68, 0.77, 0.84, and ultimately 0.93, with every incremental adjustment supported by authenticated blockchain evidence corresponding to the associated validation activities. Such chronological preservation enables comprehensive auditability of trust evolution

In an embodiment, processing the collaborative model updates further comprises generating a cryptographic commitment corresponding to each proposed model update before transmitting the proposed model update for validation, maintaining association between the cryptographic commitment and the corresponding proposed model update throughout validation, verifying consistency between the proposed model update and the corresponding cryptographic commitment before determination of acceptance, and discarding proposed model updates determined to be inconsistent with the corresponding cryptographic commitment.

Rather than assuming that a locally generated model update remains unchanged throughout communication and validation, the present embodiment establishes a verifiable computational identity for every proposed model update before it leaves the originating network node. This computational identity enables every subsequent processing stage to verify that the numerical parameters, structural arrangement, and computational contents of the proposed model update remain identical to those originally generated during local training. For instance, a participating network node may complete one collaborative learning cycle after processing approximately 300,000 locally collected telemetry records over an eight-hour observation period, resulting in a proposed model update comprising nearly 3.5 million numerical parameter adjustments occupying approximately 25 MB of memory. Before any transmission occurs, the entire computational structure of the proposed model update is secured through a uniquely generated cryptographic commitment, thereby establishing a permanent integrity reference for all subsequent validation operations.

Generation of the cryptographic commitment is performed by sequentially processing the complete computational contents of the proposed model update together with predefined structural metadata associated with the update. The structural metadata may include update sequence identifiers, collaborative learning iteration numbers, model version identifiers, dimensional configuration information, parameter counts, processing timestamps, and execution context identifiers. These parameters are arranged in a predetermined computational sequence before the cryptographic transformation is performed, thereby ensuring that the generated commitment uniquely represents both the numerical contents of the proposed model update and its associated computational context. As an illustrative example, a proposed model update containing approximately 3.5 million parameter adjustment values may additionally include metadata specifying collaborative learning iteration number 184, model revision 7.2.1, generation timestamp 14:37:28.652, and update identifier CU-184-042. Processing the complete update together with these metadata elements produces a fixed-length cryptographic commitment that uniquely identifies the proposed model update. Any subsequent alteration, including modification of a single numerical adjustment value or replacement of the associated model revision identifier, produces a completely different cryptographic commitment, thereby enabling reliable detection of unintended modification or malicious manipulation.

Following generation of the cryptographic commitment, the collaborative model update management unit permanently associates the generated commitment with the corresponding proposed model update before initiating transmission to the validator nodes. The association is maintained by embedding a unique reference identifier within both the proposed model update and the corresponding commitment record, allowing every validator node to establish an unequivocal relationship between the received computational update and its associated integrity value. Rather than maintaining the commitment as an independent verification object, the present embodiment continuously preserves the association throughout the complete validation lifecycle so that every processing operation performed upon the proposed model update simultaneously references the corresponding cryptographic commitment. For example, where multiple proposed model updates are generated simultaneously by different participating network nodes, each proposed model update is paired with its own dedicated cryptographic commitment through unique update identifiers, thereby eliminating ambiguity during concurrent validation of multiple collaborative learning contributions.

In an embodiment, incorporating the accepted model updates into the collaborative model state comprises sequentially incorporating accepted model updates according to blockchain ordering, generating an updated collaborative model state after incorporation of each accepted model update, generating a cryptographic representation corresponding to the updated collaborative model state, and associating the cryptographic representation with the blockchain block corresponding to incorporation of the accepted model update.

In an embodiment, following completion of decentralized validation and determination that one or more proposed model updates satisfy the predefined acceptance criteria, the collaborative model update management unit initiates incorporation of the accepted model updates into the collaborative model state. Instead of simultaneously applying all accepted updates, which may produce inconsistent computational outcomes due to overlapping parameter modifications or conflicting optimization directions, the present embodiment incorporates the accepted model updates sequentially according to blockchain ordering. The blockchain ordering represents the deterministic sequence established by the blockchain consensus mechanism during validation of the accepted model updates and is identical across every participating network node maintaining synchronization with the distributed ledger. Since each accepted model update is permanently associated with a unique blockchain transaction and corresponding blockchain block, every participating node retrieves the accepted model updates in precisely the same chronological order before incorporation. For example, if four accepted model updates are recorded in blockchain transactions T105, T106, T107, and T108 within consecutive blockchain blocks, each participating network node incorporates the updates strictly in the sequence T105→T106→T107→T108 irrespective of the order in which the updates were originally received or locally validated. This deterministic incorporation procedure ensures that geographically distributed participating nodes independently generate an identical collaborative model state without requiring additional synchronization exchanges after incorporation.

Before application of each accepted model update, the collaborative model update management unit retrieves the current collaborative model state together with the computational metadata associated with the accepted model update. The collaborative model state represents the latest validated computational configuration of the intrusion detection model maintained by the participating network node and includes parameter matrices, feature transformation coefficients, behavioural representation mappings, computational thresholds, inference configuration values, optimization metadata, and execution descriptors. The accepted model update similarly comprises validated computational refinements representing incremental modifications to selected portions of the collaborative model state. During incorporation, the management unit first verifies that the collaborative model state corresponds to the blockchain block immediately preceding the accepted model update to prevent incorporation upon an outdated or inconsistent model revision. As an illustrative example, if the accepted model update references collaborative model revision 128 corresponding to blockchain block 1,860,412, the management unit confirms that the locally maintained collaborative model state also represents revision 128 before permitting incorporation. If a discrepancy is detected because the participating node has not yet synchronized with the required blockchain block, incorporation is temporarily deferred until synchronization is completed, thereby preventing generation of divergent collaborative model states among participating organizations.

Once consistency has been confirmed, the accepted model update is sequentially incorporated into the collaborative model state by modifying only those computational components identified within the validated update. Rather than replacing the complete collaborative model, the management unit selectively updates corresponding computational structures while preserving unaffected portions of the existing model. Depending upon the nature of the collaborative learning framework, incorporation may include updating numerical parameter values, refining feature transformation coefficients, adjusting behavioural representation mappings, recalibrating classification thresholds, modifying optimization coefficients, updating normalization parameters, or revising decision boundary representations. For instance, an accepted model update containing approximately 2.4 million validated parameter refinements may modify only 8% of the total computational parameters maintained within a collaborative intrusion detection model comprising nearly 30 million parameters. The remaining computational structures continue to operate unchanged, thereby reducing computational overhead while ensuring that only independently validated refinements influence the evolving collaborative model state.

During incorporation, the collaborative model update management unit continuously monitors the computational integrity of the evolving collaborative model to ensure that every validated refinement is correctly integrated into the existing parameter structure. The updated parameter values are checked for dimensional consistency, numerical validity, structural compatibility, and computational continuity before the updated collaborative model state is finalized. As an illustrative example, if an accepted model update modifies behavioural feature transformation coefficients corresponding to encrypted communication timing analysis, the management unit verifies that the updated coefficients remain compatible with the dimensional structure of adjacent behavioural processing layers and that the resulting parameter ranges remain within predefined computational limits, such as normalized values between-1.0 and +1.0. If any computational inconsistency is identified during incorporation, the management unit temporarily suspends the update procedure, restores the immediately preceding collaborative model state from protected memory, records the inconsistency for diagnostic evaluation, and resumes incorporation only after successful verification of computational integrity.

Immediately after incorporation of an accepted model update, the collaborative model update management unit generates an updated collaborative model state representing the complete computational configuration of the intrusion detection model following application of the validated refinements. The updated collaborative model state therefore reflects not only the accepted computational modifications introduced by the current update but also every previously incorporated refinement accepted during earlier collaborative learning cycles. For example, if blockchain block 1,860,413 contains the fiftieth accepted model update incorporated during a particular operational period, the resulting updated collaborative model state represents the cumulative effect of all fifty accepted collaborative refinements applied in blockchain order. This continuously evolving collaborative model state subsequently becomes the baseline computational configuration used for local intrusion detection, future collaborative learning iterations, encrypted threat signature generation, and validation of subsequent proposed model updates generated by participating network nodes.

Following generation of the updated collaborative model state, the collaborative model update management unit immediately generates a cryptographic representation corresponding to the updated collaborative model state. The cryptographic representation uniquely identifies the complete computational configuration of the updated model without requiring storage or transmission of the model itself. During generation of the cryptographic representation, the management unit processes every computational element constituting the updated collaborative model, including validated parameter values, feature transformation mappings, behavioural representation structures, computational thresholds, normalization parameters, and associated execution metadata, through a cryptographic transformation procedure configured to produce a deterministic fixed-length computational identifier. As an illustrative example, an updated collaborative model occupying approximately 520 MB and comprising nearly 32 million numerical parameters may generate a 256-bit cryptographic representation that uniquely corresponds to the entire model configuration. Even an insignificant modification, such as altering a single parameter by 0.0000005, results in a completely different cryptographic representation, thereby enabling reliable verification of model integrity during future synchronization, forensic analysis, or collaborative validation activities.

The generated cryptographic representation is subsequently associated with the blockchain block corresponding to incorporation of the accepted model update. More specifically, the collaborative model update management unit establishes a permanent computational relationship between the updated collaborative model state and the blockchain transaction responsible for introducing the validated refinement into the decentralized learning framework. This association may include storing the cryptographic representation together with the blockchain block identifier, transaction sequence number, incorporation timestamp, collaborative model revision identifier, accepted update identifier, validator consensus reference, and synchronization metadata. For example, if incorporation of an accepted model update is completed during blockchain block 1,860,413 and transaction identifier TX-0245, the corresponding cryptographic representation is permanently linked with both identifiers so that every future retrieval operation can unambiguously identify the exact collaborative model configuration generated by that incorporation event. Because every participating network node performs incorporation according to identical blockchain ordering, independently generated cryptographic representations corresponding to the same blockchain block remain identical across the decentralized network, thereby providing an efficient mechanism for verifying synchronization among participating organizations without exchanging complete collaborative model states.

In another implementation, the association between the cryptographic representation and the blockchain block further supports efficient rollback and reconstruction of historical collaborative model states whenever retrospective verification or forensic investigation becomes necessary. Suppose an authorized investigator requests verification of a cyber threat detection event that occurred three months earlier and was processed using collaborative model revision 314 corresponding to blockchain block 1,875,120. Rather than reconstructing every intermediate collaborative learning iteration from the initial deployment of the system, the collaborative model update management unit retrieves the cryptographic representation associated with blockchain block 1,875,120, verifies its integrity against the archived collaborative model state maintained within protected storage, confirms correspondence with the blockchain transaction responsible for incorporation, and reconstructs the exact computational configuration responsible for the historical detection event. Because the cryptographic representation uniquely identifies the complete collaborative model configuration, reconstruction can be performed accurately without ambiguity even after thousands of additional collaborative learning cycles have subsequently modified the operational intrusion detection model.

By incorporating accepted model updates strictly according to immutable blockchain ordering, verifying computational consistency before every incorporation, generating a new collaborative model state immediately after each validated refinement, producing a cryptographic representation uniquely corresponding to the updated collaborative model configuration, and permanently associating the cryptographic representation with the blockchain block responsible for the incorporation event, the present embodiment establishes a deterministic and verifiable collaborative model evolution mechanism. This implementation ensures that all participating network nodes independently maintain identical collaborative intrusion detection models despite operating across geographically distributed environments, strengthens synchronization integrity throughout successive collaborative learning cycles, enables efficient verification and reconstruction of historical model configurations, reduces the possibility of divergence arising from asynchronous update application, and provides a cryptographically verifiable computational lineage linking every accepted model refinement to the precise blockchain transaction through which the collaborative model evolved.

In an embodiment, generating the model-state anchor comprises generating a cryptographic hash corresponding to the collaborative model state, generating a cryptographic hash corresponding to training-data commitments associated with the collaborative model state, generating a chained reference corresponding to a preceding model-state anchor, combining the cryptographic hashes and the chained reference into the model-state anchor, and associating the model-state anchor with the blockchain block corresponding to acceptance of the collaborative model update.

In an embodiment, following completion of decentralized validation and determination that one or more proposed model updates satisfy the predefined acceptance criteria, the collaborative model update management unit initiates incorporation of the accepted model updates into the collaborative model state. Instead of simultaneously applying all accepted updates, which may produce inconsistent computational outcomes due to overlapping parameter modifications or conflicting optimization directions, the present embodiment incorporates the accepted model updates sequentially according to blockchain ordering. The blockchain ordering represents the deterministic sequence established by the blockchain consensus mechanism during validation of the accepted model updates and is identical across every participating network node maintaining synchronization with the distributed ledger. Since each accepted model update is permanently associated with a unique blockchain transaction and corresponding blockchain block, every participating node retrieves the accepted model updates in precisely the same chronological order before incorporation. For example, if four accepted model updates are recorded in blockchain transactions T105, T106, T107, and T108 within consecutive blockchain blocks, each participating network node incorporates the updates strictly in the sequence T105→T106→T107→T108 irrespective of the order in which the updates were originally received or locally validated. This deterministic incorporation procedure ensures that geographically distributed participating nodes independently generate an identical collaborative model state without requiring additional synchronization exchanges after incorporation.

Before application of each accepted model update, the collaborative model update management unit retrieves the current collaborative model state together with the computational metadata associated with the accepted model update. The collaborative model state represents the latest validated computational configuration of the intrusion detection model maintained by the participating network node and includes parameter matrices, feature transformation coefficients, behavioural representation mappings, computational thresholds, inference configuration values, optimization metadata, and execution descriptors. The accepted model update similarly comprises validated computational refinements representing incremental modifications to selected portions of the collaborative model state. During incorporation, the management unit first verifies that the collaborative model state corresponds to the blockchain block immediately preceding the accepted model update to prevent incorporation upon an outdated or inconsistent model revision. As an illustrative example, if the accepted model update references collaborative model revision 128 corresponding to blockchain block 1,860,412, the management unit confirms that the locally maintained collaborative model state also represents revision 128 before permitting incorporation. If a discrepancy is detected because the participating node has not yet synchronized with the required blockchain block, incorporation is temporarily deferred until synchronization is completed, thereby preventing generation of divergent collaborative model states among participating organizations.

Following generation of the updated collaborative model state, the collaborative model update management unit immediately generates a cryptographic representation corresponding to the updated collaborative model state. The cryptographic representation uniquely identifies the complete computational configuration of the updated model without requiring storage or transmission of the model itself. During generation of the cryptographic representation, the management unit processes every computational element constituting the updated collaborative model, including validated parameter values, feature transformation mappings, behavioural representation structures, computational thresholds, normalization parameters, and associated execution metadata, through a cryptographic transformation procedure configured to produce a deterministic fixed-length computational identifier. As an illustrative example, an updated collaborative model occupying approximately 520 MB and comprising nearly 32 million numerical parameters may generate a 256-bit cryptographic representation that uniquely corresponds to the entire model configuration. Even an insignificant modification, such as altering a single parameter by 0.0000005, results in a completely different cryptographic representation, thereby enabling reliable verification of model integrity during future synchronization, forensic analysis, or collaborative validation activities.

The generated cryptographic representation is subsequently associated with the blockchain block corresponding to incorporation of the accepted model update. More specifically, the collaborative model update management unit establishes a permanent computational relationship between the updated collaborative model state and the blockchain transaction responsible for introducing the validated refinement into the decentralized learning framework. This association may include storing the cryptographic representation together with the blockchain block identifier, transaction sequence number, incorporation timestamp, collaborative model revision identifier, accepted update identifier, validator consensus reference, and synchronization metadata. For example, if incorporation of an accepted model update is completed during blockchain block 1,860,413 and transaction identifier TX-0245, the corresponding cryptographic representation is permanently linked with both identifiers so that every future retrieval operation can unambiguously identify the exact collaborative model configuration generated by that incorporation event. Because every participating network node performs incorporation according to identical blockchain ordering, independently generated cryptographic representations corresponding to the same blockchain block remain identical across the decentralized network, thereby providing an efficient mechanism for verifying synchronization among participating organizations without exchanging complete collaborative model states.

In an embodiment, generating the detection attestation package comprises generating a first cryptographic digest corresponding to the encrypted threat signature, generating a second cryptographic digest corresponding to the cryptographic commitment, arranging the first cryptographic digest, the second cryptographic digest, the identity information, the version information and the blockchain state reference in a predetermined sequence to generate a verification record, generating a verification digest from the verification record, incorporating the verification digest within the detection attestation package before transmission to the blockchain network, and maintaining the encrypted threat signature and the cryptographic commitment unchanged following generation of the verification digest until completion of validation of the detection attestation package.

Initially, the detection attestation generation unit generates a first cryptographic digest corresponding exclusively to the encrypted threat signature. The encrypted threat signature represents the encrypted behavioural characteristics derived from the latent feature representation and serves as the principal computational evidence describing the identified network event. Since the encrypted threat signature may comprise multiple encrypted computational segments arranged according to a predefined positional sequence, the generation unit first serializes the complete encrypted threat signature into a deterministic computational format preserving segment ordering, positional correspondence information, segment identifiers, computational offsets, and structural delimiters. The serialized representation is subsequently processed through a cryptographic transformation procedure to generate the first cryptographic digest. The resulting digest uniquely represents the complete encrypted threat signature such that modification of any encrypted computational segment, positional identifier, or structural parameter produces an entirely different digest value. As an illustrative example, an encrypted threat signature comprising sixteen encrypted computational segments may generate a 256-bit first cryptographic digest, wherein alteration of a single encrypted segment or exchange of the positions of two neighbouring segments immediately invalidates the corresponding digest during subsequent verification.

Following generation of the first cryptographic digest, the detection attestation generation unit independently generates a second cryptographic digest corresponding to the cryptographic commitment associated with the processed network telemetry. The cryptographic commitment itself uniquely represents the processed telemetry from which the latent feature representation was generated and therefore constitutes an independent integrity reference separate from the encrypted threat signature. Rather than incorporating the cryptographic commitment directly into the higher-level verification process, the present embodiment first generates a dedicated digest corresponding solely to the cryptographic commitment. During this process, the cryptographic commitment together with associated structural metadata, including commitment length indicators, generation identifiers, and processing sequence parameters, is transformed into a standardized computational representation before generation of the second cryptographic digest. For example, a 256-bit cryptographic commitment generated from approximately 28 MB of processed telemetry may produce a corresponding second cryptographic digest that changes completely even if one bit of the original cryptographic commitment is modified. Maintaining separate cryptographic digests for the encrypted threat signature and the cryptographic commitment enables validator nodes to distinguish between integrity failures affecting behavioural evidence and integrity failures affecting telemetry authentication information.

After generation of the first and second cryptographic digests, the detection attestation generation unit constructs a verification record by arranging the first cryptographic digest, the second cryptographic digest, the identity information, the version information, and the blockchain state reference according to a predetermined computational sequence. The predetermined sequence ensures that every participating network node assembles an identical verification record irrespective of differences in processor architecture, operating environment, or communication order. In one implementation, the first cryptographic digest occupies the initial section of the verification record, followed sequentially by the second cryptographic digest, authenticated identity information identifying the trusted execution environment, version information specifying the computational revision of the intrusion detection model, and finally the blockchain state reference identifying the distributed ledger condition corresponding to the identified network event. Structural identifiers, field length descriptors, sequence delimiters, and positional markers are additionally incorporated into the verification record to eliminate ambiguity during reconstruction by validator nodes. As an illustrative example, the verification record may comprise approximately 900 bytes containing the ordered digests, authenticated execution identifier, model version descriptor, blockchain block identifier, transaction sequence number, consensus epoch identifier, and associated synchronization metadata arranged in an identical computational format throughout the decentralized cybersecurity network.

The completed verification record is subsequently processed by the detection attestation generation unit to generate a verification digest representing the integrity of the complete verification structure. Unlike the first and second cryptographic digests, which independently protect individual computational components, the verification digest protects the authenticated relationship among the encrypted threat signature, the cryptographic commitment, the trusted execution environment, the intrusion detection model version, and the blockchain synchronization state. The generation unit sequentially processes the entire verification record through a cryptographic transformation procedure to produce a fixed-length verification digest uniquely corresponding to the assembled verification record. Consequently, alteration of any constituent element contained within the verification record, including replacement of the authenticated identity information, modification of the intrusion detection model version, substitution of the blockchain state reference, or replacement of either cryptographic digest, results in immediate generation of a different verification digest. For instance, changing the blockchain block identifier from block 1,625,840 to block 1,625,841 while preserving all remaining verification parameters produces a completely different verification digest, thereby enabling reliable identification of even minor inconsistencies affecting the authenticated relationship among the constituent elements.

Upon successful generation of the verification digest, the detection attestation generation unit incorporates the verification digest within the detection attestation package before transmission to the blockchain network. The verification digest is maintained as an independent verification field positioned according to a predefined package format together with the encrypted threat signature, the cryptographic commitment, the identity information, the version information, and the blockchain state reference. Every validator node receiving the detection attestation package therefore obtains not only the original computational elements but also the hierarchical verification information necessary to independently reconstruct the verification record and regenerate the verification digest. As an illustrative example, the detection attestation package may comprise a package header, encrypted threat signature, cryptographic commitment, identity information, version information, blockchain state reference, first cryptographic digest, second cryptographic digest, verification digest, integrity metadata, and communication trailer arranged according to a deterministic structural layout occupying approximately 11 kilobytes. Because the verification digest accompanies the package throughout communication, blockchain synchronization, temporary storage, and validator processing, every participating validator can independently confirm that the complete verification structure remains identical to that originally generated within the trusted execution environment.

Before initiating homomorphic similarity computation or consensus evaluation, each validator node independently reconstructs the verification record by regenerating the first cryptographic digest from the received encrypted threat signature, regenerating the second cryptographic digest from the received cryptographic commitment, arranging the regenerated digests together with the received identity information, version information, and blockchain state reference according to the identical predetermined sequence, and regenerating a verification digest from the reconstructed verification record. The regenerated verification digest is then compared with the verification digest contained within the received detection attestation package. Successful correspondence confirms not only that the encrypted threat signature and the cryptographic commitment remain individually unaltered but also that their authenticated association with the execution environment, model version, and blockchain state has been preserved throughout transmission and storage. Conversely, if an unauthorized entity attempts to substitute a different blockchain state reference, alter the model version identifier, replace the encrypted threat signature, or modify the cryptographic commitment after generation of the verification digest, regeneration of the verification digest immediately produces a value different from the transmitted verification digest, causing the validator node to reject the package before any consensus computation is performed. In an embodiment, processing the detection attestation package comprises generating a validator-specific encrypted corroboration entry for each selected validator node, associating each validator-specific encrypted corroboration entry with a validator identifier and the blockchain state reference corresponding to the detection attestation package, arranging the validator-specific encrypted corroboration entries into an encrypted corroboration dataset while preserving correspondence between the validator identifiers and the respective validator-specific encrypted corroboration entries, and determining the consensus validation condition by processing the encrypted corroboration dataset.

Generation of each validator-specific encrypted corroboration entry begins immediately after the validator node completes encrypted similarity evaluation and determines whether the locally generated encrypted telemetry representation satisfies the predefined similarity condition relative to the received encrypted threat signature. The validator node assembles a structured encrypted validation record comprising the encrypted similarity determination together with computational information describing the validation process. The validator-specific encrypted corroboration entry may include an encrypted validation indicator representing whether behavioural correspondence has been established, an encrypted confidence representation indicating computational consistency of the similarity evaluation, encrypted processing status information, encrypted validation completion indicators, encrypted integrity verification parameters, and encrypted synchronization metadata generated during execution of the validator-side processing workflow. Rather than exposing numerical similarity values or behavioural descriptors extracted from the local telemetry, every computational parameter included within the validator-specific encrypted corroboration entry remains encrypted before leaving the validator node. As an illustrative example, a validator node processing approximately 48,000 locally generated telemetry records may produce an encrypted corroboration entry occupying nearly 700 bytes that encapsulates the complete validation outcome without revealing any feature values, behavioural characteristics, encrypted telemetry representations, or intermediate similarity computations responsible for producing the validation result.

Following generation of the validator-specific encrypted corroboration entry, the consensus validation unit associates the entry with a validator identifier uniquely corresponding to the validator node responsible for generating the corroboration evidence. The validator identifier provides a persistent computational reference enabling subsequent processing stages to distinguish validation evidence originating from different participating nodes without revealing organization-specific operational information. The validator identifier may comprise a blockchain-registered node identifier, consensus participant identifier, cryptographically authenticated execution identifier, distributed ledger membership identifier, or another unique computational reference assigned during validator registration. Before association, the validator identifier is authenticated against validator registration information maintained within the blockchain ledger to confirm that the corroboration entry originates from an authorized validator participating in the current consensus session. For example, validator nodes registered as V-012, V-018, V-024, and V-031 respectively generate independent validator-specific encrypted corroboration entries, each permanently associated with its corresponding validator identifier throughout subsequent consensus processing. This association enables the consensus validation unit to preserve complete traceability of every validation contribution while preventing duplication, substitution, or unauthorized generation of corroboration evidence.

In addition to the validator identifier, every validator-specific encrypted corroboration entry is associated with the blockchain state reference corresponding to the detection attestation package undergoing validation. The blockchain state reference uniquely identifies the distributed ledger condition existing when the originating detection attestation package was generated and transmitted for decentralized validation. Associating every validator-specific corroboration entry with the same blockchain state reference ensures that validation evidence generated during different consensus sessions or corresponding to unrelated threat detection events cannot be inadvertently combined during consensus processing. The blockchain state reference may include a validated blockchain block identifier, transaction identifier, consensus epoch number, ledger synchronization sequence, validation session identifier, or timestamp generated during creation of the detection attestation package. As an illustrative example, if the received detection attestation package references blockchain block number 1,972,845 and transaction sequence TX- 0382, every validator-specific encrypted corroboration entry generated during the corresponding validation session explicitly incorporates these blockchain references before transmission. Consequently, all corroboration entries received by the consensus validation unit remain computationally synchronized with the originating detection event, thereby eliminating ambiguity when multiple threat detection events are simultaneously undergoing decentralized validation.

After receiving validator-specific encrypted corroboration entries from all selected validator nodes, the consensus validation unit constructs an encrypted corroboration dataset representing the complete decentralized validation evidence corresponding to the identified network event. Rather than merely storing the received corroboration entries sequentially, the consensus validation unit arranges the entries according to a predefined organizational structure that preserves deterministic correspondence between each validator identifier and its associated validator-specific encrypted corroboration entry. More specifically, every validator-specific encrypted corroboration entry is positioned within the encrypted corroboration dataset according to the authenticated validator identifier, thereby ensuring that every validator contribution occupies a unique and reproducible location within the dataset irrespective of the order in which individual validator responses are received. For example, if validator identifiers V-003, V-007, V-014, V-019, and V-027 participate in a validation session, the encrypted corroboration dataset arranges the corresponding validator-specific encrypted corroboration entries according to ascending validator identifier values rather than communication arrival order. Consequently, even when validator V-027 transmits its corroboration entry before validator V-003 because of network latency differences, the encrypted corroboration dataset ultimately stores the entries according to the predefined validator ordering, thereby ensuring identical dataset construction across all synchronized consensus nodes.

The encrypted corroboration dataset further preserves one-to-one correspondence between every validator identifier and the associated validator-specific encrypted corroboration entry throughout the complete consensus lifecycle. This correspondence is maintained by incorporating structural references, positional identifiers, sequence markers, integrity verification values, and synchronization parameters linking every validator identifier directly to its respective encrypted corroboration entry. Such preservation enables subsequent audit and forensic reconstruction of validator participation without requiring exposure of confidential validation information. For example, during post-incident verification, the consensus validation unit may retrieve the encrypted corroboration dataset corresponding to a historical threat detection event and immediately determine that validator V-014 generated the encrypted corroboration entry occupying the fourth dataset position, while validator V-027 generated the encrypted corroboration entry occupying the eighth dataset position, without revealing the encrypted validation contents associated with either validator. Maintaining this deterministic correspondence additionally prevents validator responses from being incorrectly attributed during distributed processing, thereby improving reliability of decentralized consensus.

Before determining the consensus validation condition, the consensus validation unit verifies completeness and structural integrity of the encrypted corroboration dataset. The verification procedure confirms that every validator-specific encrypted corroboration entry possesses a corresponding authenticated validator identifier, references the correct blockchain state reference, satisfies the predefined dataset structure, and contains valid integrity verification information. Dataset completeness may additionally be evaluated by comparing the number of received validator-specific corroboration entries with the number of validator nodes originally selected for participation. As an illustrative example, where twenty validator nodes were selected during validator selection and nineteen validator-specific encrypted corroboration entries are received within a predefined response interval of six seconds, the consensus validation unit determines whether the configured participation threshold, such as eighteen valid validator responses, has been achieved before proceeding with consensus evaluation. Validator-specific encrypted corroboration entries arriving after expiration of the response interval may be incorporated into subsequent audit records without influencing the ongoing consensus determination.

The encrypted corroboration dataset is subsequently processed as a unified computational structure for determining whether the consensus validation condition has been satisfied. Rather than independently evaluating validator responses in isolation, the consensus validation unit analyses the collective characteristics represented by the complete encrypted corroboration dataset. During processing, the unit evaluates validator-specific encrypted corroboration entries while preserving the correspondence with the associated validator identifiers, thereby enabling weighted consensus decisions based upon authenticated validator participation, validation consistency, historical participation behaviour, synchronization integrity, encrypted confidence information, and blockchain association parameters.

By generating independent validator-specific encrypted corroboration entries for every selected validator node, permanently associating each corroboration entry with an authenticated validator identifier and the blockchain state reference corresponding to the detection attestation package, arranging the validator-specific encrypted corroboration entries within a structured encrypted corroboration dataset while preserving deterministic correspondence with their respective validator identifiers, and determining the consensus validation condition by processing the encrypted corroboration dataset as a unified decentralized validation structure, the present embodiment establishes a highly reliable consensus mechanism that accurately reflects distributed behavioural evidence generated across multiple participating organizational environments.

In an embodiment, the encrypted threat signature is maintained in association with the detection attestation package throughout validation of the identified network event, transferring the encrypted threat signature into the blockchain record responsive to determining that the consensus validation condition is satisfied, propagating the encrypted threat signature to participating network nodes from the blockchain record, associating the propagated encrypted threat signature with the blockchain record during maintenance of the verifiable model-state history, and retrieving the encrypted threat signature from the blockchain record during generation of the cryptographic proof.

Throughout the validation process, the encrypted threat signature remains computationally immutable while the associated detection attestation package undergoes integrity verification, validator selection, encrypted similarity evaluation, corroboration generation, and consensus determination. The encrypted threat signature is retained within protected memory together with its associated detection attestation package until decentralized validation has been completed. During this interval, every validator node retrieves the encrypted threat signature exclusively through the associated detection attestation package rather than through independent communication channels or temporary storage structures. Consequently, every validator processes precisely the same encrypted behavioural representation that was originally generated within the authenticated trusted execution environment. For instance, where twenty validator nodes independently receive the same detection attestation package, each validator retrieves the encrypted threat signature from the package after successful integrity verification and performs encrypted similarity computation using an identical cryptographic representation, thereby eliminating inconsistencies that could otherwise arise if multiple versions of the encrypted threat signature were independently distributed.

Responsive to determining that the consensus validation condition has been satisfied, the blockchain record management unit transfers the encrypted threat signature directly from the validated detection attestation package into the blockchain record without regenerating, re-encrypting, or modifying the encrypted computational segments constituting the encrypted threat signature. More specifically, once the collective corroboration record confirms that the predetermined validator agreement threshold has been achieved, the blockchain record management unit extracts the already validated encrypted threat signature together with its associated integrity information and incorporates the encrypted threat signature into the blockchain record as immutable consensus evidence. Since the encrypted threat signature transferred into the blockchain record is identical to the cryptographic representation processed throughout the validator consensus stage, continuity of evidence is preserved from initial threat detection through permanent blockchain recording. As an illustrative example, an encrypted threat signature comprising sixteen encrypted computational segments validated by twenty-three out of twenty-five participating validator nodes is transferred without modification into blockchain block number 1,782,415 immediately following successful consensus completion. No additional encryption, feature transformation, or behavioural reconstruction is performed during this transfer, thereby preserving cryptographic consistency between the validated evidence and the permanently recorded blockchain representation.

Following successful commitment of the blockchain record to the distributed ledger, the blockchain communication unit initiates propagation of the encrypted threat signature to participating network nodes by retrieving the encrypted threat signature directly from the blockchain record rather than from temporary consensus processing buffers. Retrieval from the committed blockchain record guarantees that every participating network node receives the authenticated and permanently recorded version of the encrypted threat signature corresponding exactly to the blockchain transaction accepted through decentralized consensus. The blockchain communication unit establishes authenticated communication sessions with synchronized participating network nodes and sequentially distributes the encrypted threat signature together with the corresponding blockchain block identifier, transaction reference, integrity verification parameters, and synchronization metadata. For example, where approximately 650 participating network nodes are connected through the decentralized cybersecurity network, the encrypted threat signature may be propagated to all synchronized nodes within approximately four seconds following commitment of the blockchain block, allowing every node to incorporate the validated encrypted behavioural representation into its local threat intelligence repository without requiring access to the originating organization's confidential telemetry. Each receiving node independently verifies the associated blockchain integrity information before accepting the propagated encrypted threat signature, thereby ensuring that only blockchain-authenticated threat intelligence participates in subsequent collaborative detection activities.

The propagated encrypted threat signature remains continuously associated with the blockchain record during maintenance of the verifiable model-state history so that future collaborative model evolution can be directly correlated with the validated threat intelligence responsible for influencing subsequent model refinements. More specifically, whenever the accepted network event contributes to collaborative learning activities resulting in one or more accepted model updates, the model-state history management unit references the blockchain record containing the propagated encrypted threat signature while generating the corresponding model-state anchor. Instead of storing duplicate copies of the encrypted threat signature within individual model-state anchors, the model-state history management unit maintains a persistent blockchain association linking every relevant model-state anchor to the blockchain record containing the validated encrypted threat signature. As an illustrative example, if three successive collaborative model updates incorporate behavioural knowledge derived from the same validated encrypted threat signature, the corresponding three model-state anchors each reference the blockchain record containing the encrypted threat signature while preserving independent cryptographic hashes representing the evolving collaborative model state. This persistent association enables subsequent verification procedures to identify precisely which validated threat intelligence contributed to each stage of collaborative model evolution without introducing redundant storage of encrypted behavioural representations across multiple blockchain records.

In an embodiment, recording the identified network event comprises constructing the blockchain record by sequentially incorporating the detection attestation package, the encrypted corroboration information, the updated reputation value and the blockchain state reference into a verification structure, generating a cryptographic hash representative of the verification structure, storing the verification structure and the cryptographic hash together within the blockchain record, and associating the blockchain record with a subsequent blockchain block for maintaining chronological correspondence between validated network events. For example, following successful decentralized validation involving twenty validator nodes, the blockchain record management unit constructs a verification structure representing the complete validated event using approximately 12 to 15 kilobytes of cryptographically protected information instead of storing several megabytes of raw telemetry or intermediate processing data, thereby substantially reducing blockchain storage overhead while preserving complete evidentiary traceability.

Initially, the blockchain record management unit sequentially incorporates the detection attestation package into the verification structure. The detection attestation package represents the authenticated computational evidence generated during the threat detection stage and includes the encrypted threat signature, cryptographic commitments, verification digests, identity information corresponding to the authenticated execution environment, version information identifying the intrusion detection model, blockchain state references, integrity verification parameters, and associated synchronization metadata. Rather than embedding these elements in arbitrary order, the blockchain record management unit serializes the detection attestation package according to a predefined structural format preserving the original logical organization established during package generation. The package header, encrypted computational components, authentication parameters, verification digests, integrity fields, and structural delimiters are sequentially arranged to ensure deterministic interpretation by every participating blockchain node. For example, a detection attestation package occupying approximately 10 kilobytes may be incorporated as the first computational section of the verification structure, thereby establishing the authenticated behavioural evidence upon which all subsequent blockchain record elements are organized.

Following incorporation of the detection attestation package, the blockchain record management unit sequentially incorporates the encrypted corroboration information generated during decentralized validator consensus. The encrypted corroboration information represents the independently generated encrypted validation outcomes received from the selected validator nodes and collectively demonstrates that the identified network event has been corroborated across multiple participating organizational environments. During incorporation, the encrypted corroboration information is appended immediately after the detection attestation package while preserving validator-specific ordering, blockchain synchronization references, encrypted confidence representations, validator participation identifiers, integrity verification values, and computational sequence information. Maintaining this predefined incorporation order enables subsequent verification procedures to reconstruct the complete consensus history associated with the recorded network event without requiring retrieval of separate validator-specific records. As an illustrative example, where eighteen validator nodes participate in consensus validation, the corresponding encrypted corroboration information may occupy approximately 9 kilobytes within the verification structure, with every validator contribution arranged according to authenticated validator identifiers and consensus participation order rather than communication arrival sequence. Subsequently, the blockchain record management unit incorporates the updated reputation value associated with the originating participating network node into the verification structure. The updated reputation value reflects the validated operational history of the participating network node following successful completion of decentralized validation and propagation of the encrypted threat signature throughout the collaborative cybersecurity framework. Rather than recording the reputation value as an isolated numerical parameter, the management unit associates the updated reputation value with supplementary computational metadata including the immediately preceding reputation value, reputation adjustment magnitude, consensus participation references, validator agreement statistics, propagation completion indicators, and update timestamps. For example, a participating node maintaining a normalized reputation value of 0.84 before validation may receive an updated value of 0.89 following successful validation, propagation, and acknowledgement by 98% of participating network nodes. Both the preceding and updated reputation values, together with the adjustment metadata, are incorporated into the verification structure, thereby enabling subsequent forensic analysis to reconstruct the evolution of validator reliability throughout successive collaborative validation cycles.

After incorporation of the updated reputation information, the blockchain record management unit sequentially incorporates the blockchain state reference corresponding to the validated network event. The blockchain state reference establishes a definitive linkage between the verification structure and the precise operational condition of the distributed ledger existing when consensus validation was completed. The blockchain state reference may include the validated blockchain block identifier, transaction identifier, consensus epoch number, synchronization sequence, validation timestamp, previous block reference, and distributed ledger version information. During incorporation, the blockchain state reference is positioned as the concluding computational section of the verification structure so that the entire verification framework becomes uniquely associated with a single immutable blockchain state. As an illustrative example, if validation of the identified network event concludes during blockchain block number 2,145,308 and transaction identifier TX-0472, these references are incorporated into the verification structure immediately following the updated reputation information, thereby permanently binding the complete validation history of the identified network event to the corresponding blockchain transaction.

Once all constituent computational elements have been sequentially incorporated, the blockchain record management unit generates a structured verification framework wherein every section maintains deterministic positional correspondence with its associated computational purpose. The verification structure may additionally include section identifiers, structural boundaries, field length descriptors, computational offsets, integrity delimiters, serialization identifiers, and verification markers that facilitate identical reconstruction by every synchronized blockchain node. For instance, the verification structure may comprise a header identifying the verification format, followed by the detection attestation package, encrypted corroboration information, updated reputation section, blockchain state reference, structural integrity metadata, and a concluding verification trailer. This deterministic structural arrangement ensures that every participating blockchain node independently reconstructs an identical computational representation before subsequent integrity verification, thereby eliminating inconsistencies arising from differences in communication ordering, processor architecture, or local implementation details.

Following completion of the verification structure, the blockchain record management unit generates a cryptographic hash representative of the entire verification structure rather than generating independent integrity values for the individual computational sections. During generation of the cryptographic hash, every byte contained within the assembled verification structure is sequentially processed through a cryptographic transformation procedure so that the resulting hash uniquely represents the complete computational contents and structural organization of the verification framework. Since the cryptographic hash depends upon every incorporated computational element, modification of any constituent component-including the encrypted threat signature, validator corroboration information, reputation values, blockchain references, or structural metadata-produces a completely different hash value. As an illustrative example, a verification structure occupying approximately 24 kilobytes may generate a fixed-length 256-bit cryptographic hash, wherein modification of a single validator participation identifier or alteration of the updated reputation value by only 0.01 immediately invalidates the generated hash during subsequent verification.

After generation of the cryptographic hash, the blockchain record management unit stores both the complete verification structure and the corresponding cryptographic hash together within the blockchain record. The cryptographic hash is maintained as an integral component of the blockchain record rather than as an externally referenced integrity value, thereby ensuring that every blockchain node retrieving the record obtains both the verification structure and the associated integrity reference simultaneously. The blockchain record may therefore comprise a blockchain record header, the complete verification structure, the cryptographic hash, synchronization metadata, transaction sequencing information, and blockchain indexing parameters. For example, a blockchain record occupying approximately 25 kilobytes may allocate nearly 24.7 kilobytes for the verification structure while reserving 256 bits for the cryptographic hash together with associated indexing information identifying the blockchain transaction and storage location. Whenever the blockchain record is retrieved for forensic investigation, compliance verification, or decentralized synchronization, the stored cryptographic hash enables immediate verification that the verification structure has remained unmodified since its original incorporation into the blockchain ledger.

Before permanent commitment of the blockchain record to the distributed ledger, the blockchain record management unit performs an internal integrity verification by independently regenerating the cryptographic hash from the stored verification structure and comparing the regenerated value with the stored cryptographic hash. Successful correspondence confirms that no computational corruption has occurred during assembly of the blockchain record. Conversely, any mismatch causes reconstruction of the verification structure before blockchain commitment proceeds. This preliminary verification minimizes the possibility of permanently recording incomplete or corrupted blockchain records and ensures that every blockchain transaction committed to the distributed ledger possesses internally consistent computational evidence.

Upon successful integrity verification, the blockchain record is associated with a subsequent blockchain block generated after completion of consensus validation rather than the blockchain block that merely initiated validation of the identified network event. Associating the blockchain record with a subsequent blockchain block ensures that the complete decentralized validation procedure, validator corroboration, reputation update, integrity verification, and verification structure generation have all been finalized before permanent recording within the immutable ledger. For example, if decentralized validation begins during blockchain block 2,145,308 but concludes after generation of blockchain block 2,145,309, the finalized blockchain record is committed to blockchain block 2,145,310, thereby ensuring that the blockchain chronology accurately reflects the sequence of validation, verification, and permanent recording activities. Every subsequent validated network event is similarly associated with later blockchain blocks according to the order in which validation processes are completed, thereby preserving deterministic chronological correspondence among independently validated cyber threat events across the decentralized cybersecurity framework.

The chronological association established by recording blockchain records in successive blockchain blocks enables efficient reconstruction of distributed cyberattack progression during subsequent forensic investigations. For instance, if a coordinated attack propagates through multiple participating organizations over a period of several minutes, the corresponding blockchain records appear in successive blockchain blocks reflecting the actual order in which independent threat detections achieved decentralized validation. Investigators can therefore reconstruct the temporal evolution of the attack by sequentially retrieving blockchain records according to blockchain block order without requiring access to confidential network telemetry or organization-specific communication logs. Furthermore, because every blockchain record contains both the complete verification structure and the associated cryptographic hash, historical records remain independently verifiable even years after their original creation.

By sequentially constructing the verification structure through incorporation of the authenticated detection attestation package, decentralized encrypted corroboration information, dynamically updated reputation information, and blockchain state reference, generating a cryptographic hash representing the complete verification structure, storing both the verification structure and its corresponding cryptographic hash together within the blockchain record, and permanently associating the blockchain record with a subsequent blockchain block, the present embodiment establishes a highly reliable and chronologically consistent blockchain recording mechanism. This implementation preserves the integrity of validated cyber threat evidence, provides deterministic reconstruction of historical validation events, enables efficient verification of blockchain record authenticity without reprocessing the original detection workflow, minimizes storage overhead while maintaining complete computational traceability, and strengthens long-term evidentiary reliability across the decentralized collaborative cybersecurity infrastructure.

In an embodiment, processing the detection attestation package comprises verifying correspondence between the version information associated with the encrypted threat signature and version information associated with the intrusion detection model of each selected validator node before generation of the encrypted telemetry representation, processing the encrypted threat signature using encrypted telemetry representations generated by validator nodes determined to have corresponding version information, excluding encrypted telemetry representations generated by validator nodes determined not to have corresponding version information from determination of the consensus validation condition, and determining the consensus validation condition using encrypted corroboration information generated from the encrypted telemetry representations corresponding to the validator nodes having the corresponding version information.

Upon receipt of the detection attestation package, each selected validator node extracts the version information associated with the encrypted threat signature together with the authenticated identity information contained within the detection attestation package. The version information uniquely identifies the computational configuration of the intrusion detection model responsible for generating the encrypted threat signature and may include a collaborative model revision identifier, feature transformation configuration identifier, parameter generation sequence number, model compilation identifier, behavioural mapping revision, computational configuration checksum, or a combination thereof. Rather than representing only a numerical software version, the version information uniquely characterizes the complete computational state of the intrusion detection model used during generation of the encrypted threat signature. For example, the version information may identify collaborative model revision R-214.08, feature transformation configuration FT-36, behavioural mapping revision BM-11, and parameter configuration sequence PC-842, thereby enabling validator nodes to determine precisely which computational configuration generated the encrypted behavioural representation.

Each selected validator node independently retrieves the version information corresponding to the locally deployed intrusion detection model maintained within its hardware-attested trusted execution environment. The locally maintained version information is generated during installation of each validated collaborative model update and is continuously synchronized with the collaborative model state recorded within the blockchain ledger. The retrieved version information represents the exact computational configuration currently available for processing locally generated network telemetry and includes feature extraction parameters, behavioural transformation mappings, normalization configurations, latent representation dimensionality, computational coefficient identifiers, and associated execution metadata. For instance, one validator node may currently execute collaborative model revision R-214.08, whereas another validator node may temporarily operate using revision R-213.15 because synchronization with the most recent blockchain block has not yet been completed. Although both validator nodes remain operational, only validator nodes executing computationally compatible model revisions are permitted to participate in encrypted similarity evaluation for the received detection attestation package.

The consensus validation unit subsequently performs a correspondence verification between the version information associated with the encrypted threat signature and the locally retrieved version information maintained by each selected validator node. Rather than comparing only version numbers, the correspondence verification evaluates multiple computational attributes defining the operational characteristics of the intrusion detection model. The verification process confirms consistency of the collaborative model revision, feature transformation configuration, latent feature dimensionality, behavioural mapping identifiers, normalization parameter configuration, computational coefficient structure, and cryptographic model registration information. As an illustrative example, if the encrypted threat signature has been generated using a latent feature representation comprising 256 computational dimensions with feature transformation configuration FT-36, the validator node confirms that its locally deployed intrusion detection model generates latent feature representations having the identical dimensional structure and computational mapping. If every required computational attribute corresponds, the validator node is classified as computationally compatible for the current consensus session.

In an embodiment, processing the collaborative model updates comprises identifying the collaborative model state associated with the version information contained in the detection attestation package, verifying correspondence between the identified collaborative model state and the model-state anchor associated with the accepted collaborative model update, incorporating a subsequent accepted collaborative model update responsive to successful verification of the correspondence, and generating a subsequent model-state anchor corresponding to the incorporated collaborative model update.

In an embodiment, the collaborative model update management unit maintains continuous version-controlled evolution of the collaborative intrusion detection model by ensuring that every accepted collaborative model update is incorporated only into the precise collaborative model state from which the update has been validated. Since participating network nodes may generate and validate collaborative model updates at different points in time while operating in geographically distributed environments, multiple accepted collaborative model updates may coexist within the blockchain ledger awaiting incorporation. If these accepted updates are applied without confirming the underlying collaborative model state upon which they were generated, parameter inconsistencies, computational divergence, or unintended overwriting of previously validated refinements may occur. To eliminate such inconsistencies, the present embodiment establishes a deterministic model-state verification mechanism that confirms the integrity and lineage of the collaborative model before every incorporation event. Consequently, every accepted collaborative model update extends the exact computational state intended during decentralized validation, thereby preserving consistency of collaborative learning across all participating network nodes. Following receipt of an accepted collaborative model update, the collaborative model update management unit initially identifies the collaborative model state associated with the version information contained in the corresponding detection attestation package. The version information represents more than a simple numerical revision identifier and defines the complete computational configuration of the intrusion detection model that existed when the accepted collaborative model update was generated. The version information may comprise a collaborative model revision identifier, feature transformation configuration identifier, behavioural representation configuration, parameter generation sequence number, collaborative learning iteration identifier, computational architecture identifier, normalization configuration identifier, execution profile identifier, and associated blockchain synchronization metadata. These parameters collectively enable the collaborative model update management unit to locate the precise collaborative model state maintained within protected storage or reconstruct the required state from previously recorded blockchain information. For example, an accepted collaborative model update may specify collaborative model revision CM-428, collaborative learning iteration 215, behavioural transformation configuration BT-14, and parameter configuration PC-983, thereby uniquely identifying the computational model configuration that served as the basis for generating the accepted update.

After identifying the corresponding version information, the collaborative model update management unit retrieves the collaborative model state represented by the identified version. The retrieved collaborative model state includes the complete computational configuration of the intrusion detection model existing immediately before generation of the accepted collaborative model update. This computational configuration may include behavioural feature transformation parameters, communication representation mappings, normalization coefficients, classification parameters, computational thresholds, latent representation mappings, execution configuration descriptors, and associated cryptographic identifiers describing the operational state of the collaborative intrusion detection model. As an illustrative example, a collaborative model state corresponding to revision CM-428 may comprise approximately 34 million validated computational parameters occupying nearly 550 MB of protected memory. Rather than reconstructing the model from individual blockchain transactions, the collaborative model update management unit retrieves the validated collaborative model state directly from secure storage while simultaneously obtaining the corresponding cryptographic identifiers maintained within the associated model-state history.

Once the collaborative model state has been identified, the collaborative model update management unit retrieves the model-state anchor associated with the accepted collaborative model update. As previously described, every accepted collaborative model update is permanently associated with a corresponding model-state anchor that uniquely represents the computational state of the collaborative intrusion detection model at the time of acceptance. The retrieved model-state anchor contains a cryptographic representation of the collaborative model state together with blockchain references, chained model-state references, training-data commitments, version identifiers, update sequence information, synchronization metadata, and integrity verification parameters. Since the model-state anchor is generated immediately following incorporation of the preceding accepted collaborative model update, it provides an immutable computational reference describing the model lineage immediately prior to incorporation of the newly received collaborative model update.

The collaborative model update management unit subsequently verifies correspondence between the identified collaborative model state and the retrieved model-state anchor before permitting incorporation of the accepted collaborative model update. Rather than merely comparing version identifiers, the verification procedure evaluates whether the computational characteristics represented by the collaborative model state precisely correspond to the cryptographic representation maintained within the model-state anchor. During verification, the management unit independently generates a cryptographic representation of the retrieved collaborative model state and compares the generated representation with the cryptographic representation stored within the model-state anchor. Simultaneously, additional verification is performed by comparing collaborative model revision identifiers, blockchain references, chained anchor identifiers, behavioural transformation configurations, computational dimensionality, parameter configuration identifiers, and synchronization metadata maintained by both computational structures. As an illustrative example, the retrieved collaborative model state may generate a cryptographic representation HCM-78531, while the corresponding model-state anchor stores the identical representation HCM-78531 together with blockchain block number 2,438,516 and collaborative model revision CM-428. Successful correspondence confirms that the retrieved collaborative model state accurately represents the validated computational configuration expected for incorporation of the accepted collaborative model update.

In certain implementations, the correspondence verification additionally evaluates continuity of the model-state history to ensure that no accepted collaborative model updates have been omitted during synchronization. More specifically, the chained reference maintained within the retrieved model-state anchor is compared with the immediately preceding model-state anchor recorded within the blockchain ledger to verify uninterrupted computational lineage. If the chained references indicate that one or more accepted collaborative model updates have not yet been incorporated into the locally maintained collaborative model state, the management unit temporarily suspends incorporation of the current accepted update and retrieves the missing intermediate updates before resuming the incorporation sequence. For example, if the locally maintained collaborative model state corresponds to blockchain block 2,438,514, while the accepted collaborative model update references model-state anchor associated with blockchain block 2,438,516, the verification procedure determines that an intermediate collaborative model update associated with blockchain block 2,438,515 remains unincorporated. The management unit therefore retrieves and incorporates the missing collaborative model update before continuing with incorporation of the subsequent accepted update, thereby preserving deterministic evolution of the collaborative model across all participating network nodes.

Only after successful verification of correspondence between the identified collaborative model state and the retrieved model-state anchor does the collaborative model update management unit incorporate the subsequent accepted collaborative model update into the collaborative intrusion detection model. The incorporation process modifies only those computational structures specified by the accepted collaborative model update while preserving all previously validated refinements maintained within the existing collaborative model state. Updated parameter values, feature transformation coefficients, behavioural mappings, computational thresholds, normalization parameters, and decision boundaries are integrated according to the validated computational instructions contained within the accepted update. For example, an accepted collaborative model update modifying approximately 2.8 million computational parameters may be incorporated into a collaborative model containing nearly 34 million parameters by selectively replacing only the validated parameter subset while leaving the remaining computational structures unchanged. Because incorporation occurs only after successful correspondence verification, every accepted collaborative model update extends the precise computational state intended during decentralized validation rather than an outdated or inconsistent model revision.

Immediately after successful incorporation of the accepted collaborative model update, the collaborative model update management unit generates a subsequent collaborative model state representing the updated computational configuration of the intrusion detection model. The subsequent collaborative model state reflects the cumulative effect of every previously accepted collaborative model update together with the most recently incorporated refinement. The updated model thereafter becomes the operational intrusion detection model employed for generation of latent feature representations, encrypted threat signatures, validator-side telemetry processing, and subsequent collaborative learning cycles. As an illustrative example, incorporation of an accepted collaborative model update associated with collaborative model revision CM-428 produces a subsequent collaborative model state identified as revision CM-429, wherein the updated revision includes both historical collaborative refinements and the computational improvements introduced by the latest accepted update.

Following generation of the subsequent collaborative model state, the collaborative model update management unit immediately generates a subsequent model-state anchor corresponding to the incorporated collaborative model update. The subsequent model-state anchor uniquely represents the computational configuration of the newly generated collaborative model state and includes a cryptographic representation of the updated model, blockchain references identifying the incorporation transaction, updated collaborative model revision information, training-data commitments associated with the accepted collaborative model update, synchronization metadata, execution identifiers, and a chained reference linking the newly generated model-state anchor with the immediately preceding model-state anchor. As an illustrative example, if incorporation of collaborative model revision CM-429 occurs within blockchain block 2,438,517, the generated subsequent model-state anchor stores the cryptographic representation of revision CM-429, references blockchain block 2,438,517, and incorporates the identifier of the preceding model-state anchor associated with revision CM-428, thereby extending the immutable model-state history without interruption.

The generated subsequent model-state anchor is thereafter recorded within the blockchain ledger and becomes the authoritative computational reference for validation of all future collaborative model updates. Subsequent participating network nodes generating collaborative model refinements reference this newly generated model-state anchor when constructing future detection attestation packages and collaborative model updates, thereby ensuring that every collaborative learning cycle begins from a verified computational foundation. For example, a participating network node synchronizing with blockchain block 2,438,517 retrieves the newly generated model-state anchor corresponding to collaborative model revision CM-429 before initiating local model refinement, ensuring that every subsequent collaborative model update is generated from the most recent validated computational configuration.

By identifying the collaborative model state associated with the version information contained within the detection attestation package, verifying correspondence between the identified collaborative model state and the model-state anchor associated with the accepted collaborative model update before incorporation, permitting incorporation only after successful correspondence verification, and immediately generating a subsequent model-state anchor representing the newly incorporated collaborative model state, the present embodiment establishes a deterministic model-lineage management mechanism that preserves continuity of collaborative learning across decentralized participating network nodes. This implementation prevents incorporation of accepted collaborative model updates into incompatible model revisions, eliminates computational divergence arising from asynchronous update application, enables reliable reconstruction of model evolution throughout successive collaborative learning cycles, maintains cryptographically verifiable lineage between accepted updates and corresponding collaborative model states, and ensures that every participating node evolves the collaborative intrusion detection model according to an identical blockchain-governed computational history.

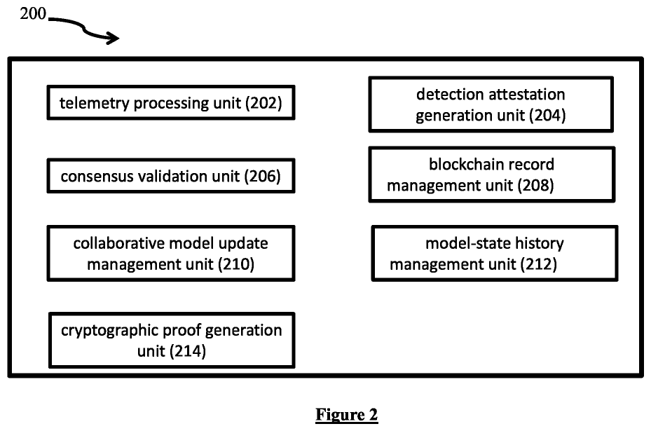

Referring to FIG. 2 a block diagram for a decentralized adversarial-resilient cyber threat detection system is illustrated. FIG. 2 illustrates an exemplary block diagram of the decentralized adversarial-resilient cyber threat detection system configured to perform the computer-implemented method illustrated in FIG. 1. The decentralized adversarial-resilient cyber threat detection system comprises one or more processors in communication with a memory and includes a telemetry processing unit, a detection attestation generation unit, a consensus validation unit, a blockchain record management unit, a collaborative model update management unit, a model-state history management unit, and a cryptographic proof generation unit. The one or more processors cooperate with the respective units to perform the operations described with reference to FIG. 1, wherein the structural components illustrated in FIG. 2 provide the hardware implementation for executing the corresponding method operations associated with decentralized cyber threat detection, collaborative validation, blockchain recording, collaborative model update validation, model-state management, and cryptographic proof generation. The system 200 comprising: a telemetry processing unit (202) implemented by one or more processors in communication with a memory and configured to receive network telemetry associated with a participating network node, process the network telemetry using an intrusion detection model operating within a hardware-attested trusted execution environment to identify a network event corresponding to a potential cyber threat, generate a latent feature representation corresponding to the identified network event, generate a cryptographic commitment representative of the processed network telemetry, and associate the latent feature representation with identity information and version information of the intrusion detection model maintained within the hardware-attested trusted execution environment; a detection attestation generation unit (204) implemented by the one or more processors and configured to encrypt the latent feature representation using a threshold homomorphic encryption scheme to obtain an encrypted threat signature, cryptographically bind the encrypted threat signature with the cryptographic commitment, the identity information, the version information and a blockchain state reference corresponding to a current blockchain state to generate a detection attestation package, and transmit the detection attestation package to a blockchain network; a consensus validation unit (206) implemented by the one or more processors and configured to process the detection attestation package by verifying authenticity of a hardware attestation associated with the detection attestation package, selecting a plurality of validator nodes according to a blockchain consensus procedure, generating encrypted telemetry representations from network telemetry locally available at the selected validator nodes using a feature transformation corresponding to generation of the encrypted threat signature, performing homomorphic similarity computation between the encrypted threat signature and the encrypted telemetry representations while maintaining the encrypted threat signature and the encrypted telemetry representations in encrypted form throughout the homomorphic similarity computation, generating encrypted corroboration information according to similarity results obtained from the homomorphic similarity computation, and determining whether the encrypted corroboration information satisfies a consensus validation condition; a blockchain record management unit (208) implemented by the one or more processors and configured to, responsive to determining that the consensus validation condition is satisfied, store the encrypted threat signature and the detection attestation package within a blockchain record, update a reputation value associated with the participating network node according to the validated network event, associate the updated reputation value with subsequent collaborative model contribution and blockchain participation, and propagate the encrypted threat signature to participating network nodes for encrypted comparison with locally generated encrypted telemetry representations without exposing underlying network telemetry associated with the participating network nodes; a collaborative model update management unit (210) implemented by the one or more processors and configured to receive cryptographic commitments corresponding to proposed model updates associated with the participating network nodes, selectively expose the proposed model updates to the selected validator nodes through authenticated secure communication established between hardware-attested trusted execution environments, generate encrypted validation information corresponding to robustness evaluation performed for the proposed model updates, determine acceptance of the proposed model updates according to the encrypted validation information received from the selected validator nodes, incorporate accepted model updates into a collaborative model state, reject model updates failing acceptance, and record an outcome corresponding to each proposed model update within the blockchain record; a model-state history management unit (212) implemented by the one or more processors and configured to generate a model-state anchor for each accepted model update, cryptographically link each model-state anchor with a preceding model-state anchor and a blockchain block corresponding to acceptance of the accepted model update, store cryptographic hashes representative of the collaborative model state and training-data commitments within the model-state anchor, and preserve a chronological model provenance corresponding to successive collaborative model updates; and a cryptographic proof generation unit (214) implemented by the one or more processors and configured to, responsive to receipt of a verification request, retrieve a model-state anchor corresponding to the recorded network event, construct a cryptographic proof using the retrieved model-state anchor, the blockchain record and the hardware attestation associated with the detection attestation package, and provide the cryptographic proof for verification of the recorded network event while retaining confidentiality of the network telemetry, the collaborative model state and the encrypted threat signature.

The decentralized cybersecurity system is implemented using dedicated electronic hardware configured to perform secure telemetry acquisition, cryptographic processing, decentralized validation, blockchain recording, and collaborative model management. The system includes at least one telemetry processing unit electrically coupled to one or more network communication interfaces configured to receive network telemetry from monitored communication links, a feature processing unit configured to generate intermediate feature values and latent feature representations using arithmetic processing circuitry, an encryption unit configured to generate encrypted threat signatures and encrypted telemetry representations using dedicated cryptographic computation circuitry, a cryptographic commitment generation unit configured to generate cryptographic commitments, cryptographic digests, verification digests, cryptographic hashes, and cryptographic proofs through hardware-based cryptographic processing circuits, and a detection attestation generation unit configured to generate detection attestation packages containing authenticated validation information. The system further includes a consensus validation unit configured to perform validator selection, encrypted similarity computation, encrypted corroboration generation, encrypted corroboration dataset construction, validator-specific encrypted corroboration entry generation, consensus validation determination, and validator correspondence verification using dedicated computational circuitry. A blockchain record management unit is configured to generate verification structures, blockchain records, blockchain state references, reputation updates, chronological blockchain associations, and immutable event records within distributed ledger storage circuitry. A collaborative model update management unit is configured to receive proposed model updates, generate and verify cryptographic commitments corresponding to the proposed model updates, verify model-state correspondence, incorporate accepted collaborative model updates, generate collaborative model states, and maintain synchronized collaborative learning across participating network nodes. A model-state history management unit is configured to generate model-state anchors, maintain chained model-state references, generate cryptographic representations of collaborative model states, preserve training-data commitments, and maintain chronological model evolution information associated with blockchain blocks. A cryptographic proof generation unit is configured to retrieve blockchain records, model-state anchors, and hardware attestations and generate verifiable cryptographic proofs for authenticated network events. The system further includes one or more hardware-attested trusted execution environments implemented by isolated processor execution circuitry and protected memory circuitry configured to retain latent feature representations, encrypted threat signatures, cryptographic commitments, and collaborative model information within protected execution regions during processing. These units are interconnected through high-speed communication buses and cooperate with processor circuitry, volatile memory, non-volatile memory, secure storage circuitry, blockchain storage circuitry, communication transceivers, and dedicated cryptographic accelerators to execute telemetry processing, encrypted behavioural analysis, decentralized consensus validation, collaborative model evolution, and immutable blockchain recording while maintaining hardware-level isolation, computational integrity, deterministic execution, and secure data propagation across participating network nodes.

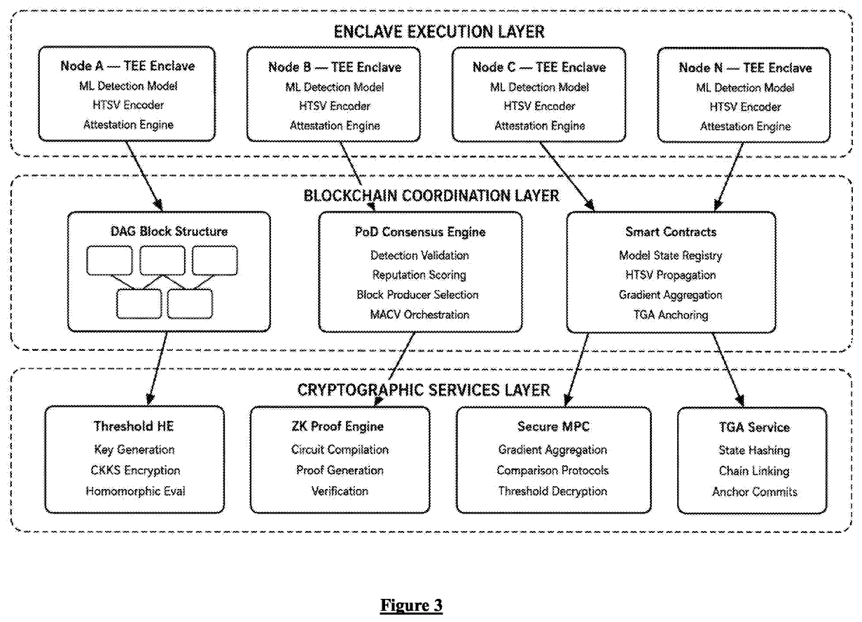

FIG. 3 illustrates an exemplary architecture of a decentralized collaborative cyber threat detection and validation system comprising an Enclave Execution Layer, a Blockchain Coordination Layer, and a Cryptographic Services Layer, wherein the three layers cooperate to perform secure threat detection, collaborative validation, distributed model governance, and cryptographically verifiable provenance generation.

The Enclave Execution Layer comprises a plurality of participating network nodes, represented as Node A, Node B, Node C, through Node N, each executing an independent Trusted Execution Environment (TEE). Each Trusted Execution Environment provides an isolated execution domain in which monitored network telemetry is processed without exposing the telemetry or intermediate computational results to software operating outside the Trusted Execution Environment. The Trusted Execution Environment of each participating network node executes an intrusion detection model configured to evaluate monitored network telemetry and determine whether the monitored network telemetry satisfies one or more threat detection criteria. Upon identifying a suspected cyber threat, the Trusted Execution Environment generates an encrypted representation of the detected communication pattern using a Homomorphic Threat Signature Vector (HTSV) Encoder, wherein the Homomorphic Threat Signature Vector Encoder transforms characteristics of the detected communication pattern into a vector representation suitable for subsequent encrypted comparison by participating network nodes. The Trusted Execution Environment further operates an Attestation Engine configured to generate cryptographic attestation information establishing that the intrusion detection model, the generated encrypted representation, and associated detection information originate from an authenticated execution environment that has not been modified after deployment. The generated attestation information is incorporated into a cryptographically verifiable detection record transmitted for collaborative validation.

The Blockchain Coordination Layer receives the cryptographically verifiable detection records generated by the participating network nodes and maintains a distributed ledger recording validation activities and collaborative model management operations. The Blockchain Coordination Layer comprises a Directed Acyclic Graph (DAG) Block Structure, a Proof-of-Detection (PoD) Consensus Engine, and a Smart Contract processing unit.

The Directed Acyclic Graph (DAG) Block Structure maintains interconnected ledger blocks arranged to permit concurrent recording of independent threat detection events while preserving cryptographic linkage among successive ledger blocks. The Directed Acyclic Graph Block Structure records authenticated detection records, encrypted validation records, accepted collaborative model updates, and cryptographically linked model-state records used for subsequent verification of threat detection events.

The Proof-of-Detection (PoD) Consensus Engine performs collaborative validation of received detection records generated by the participating network nodes. The Proof-of-Detection Consensus Engine executes detection validation by evaluating encrypted validation records generated by validating network nodes, performs reputation scoring according to historical validation performance of the participating network nodes, performs block producer selection using the updated reputation information to identify participating network nodes responsible for recording validated transactions within the distributed ledger, and performs Multi-Phase Adversarial Consensus Validation (MACV) orchestration to coordinate validation of collaborative intrusion detection model updates prior to incorporation of the collaborative intrusion detection model into the distributed system.

The Smart Contract processing unit manages distributed state information associated with collaborative operation of the participating network nodes. In one embodiment, the Smart Contract processing unit maintains a model state registry configured to record successive collaborative intrusion detection model states accepted through distributed validation, controls Homomorphic Threat Signature Vector (HTSV) propagation by distributing encrypted threat representations to participating network nodes following successful validation, performs gradient aggregation for accepted collaborative model updates contributed by the participating network nodes, and performs Temporal Gradient Anchoring (TGA) by cryptographically associating each accepted collaborative model state with a corresponding block maintained within the distributed ledger to establish an immutable sequence of collaborative model states.

The Cryptographic Services Layer provides cryptographic processing resources supporting secure operation of the decentralized collaborative cyber threat detection system. The Cryptographic Services Layer comprises a Threshold Homomorphic Encryption (Threshold HE) unit, a Zero-Knowledge Proof (ZKP) Engine, a Secure Multi-Party Computation (Secure MPC) unit, and a Temporal Gradient Anchoring (TGA) Service.

The Threshold Homomorphic Encryption unit performs key generation for establishing threshold public and private cryptographic keys shared among participating network nodes, performs encryption of vector representations generated by the participating network nodes using a Cheon-Kim-Kim-Song (CKKS) Homomorphic Encryption Scheme, and performs homomorphic evaluation enabling encrypted comparison of distributed threat representations without decrypting the encrypted information.

The Zero-Knowledge Proof Engine performs circuit compilation for constructing cryptographic verification circuits, performs proof generation to establish correctness of validated threat detection events without exposing confidential telemetry information, and performs verification of generated zero-knowledge proofs by authorized entities requesting confirmation of recorded threat detection events.

The Secure Multi-Party Computation unit performs collaborative cryptographic operations among participating network nodes without revealing confidential information exchanged between the participating network nodes. In one embodiment, the Secure Multi-Party Computation unit performs gradient aggregation for collaborative model updates, performs comparison protocols for evaluating encrypted similarity information generated during distributed validation, and performs threshold decryption only after satisfying predetermined participation criteria established for the decentralized collaborative cyber threat detection system.

The Temporal Gradient Anchoring Service performs state hashing by generating cryptographic digests representing accepted collaborative intrusion detection model states, performs chain linking by cryptographically linking each newly accepted model state with a previously accepted collaborative model state, and performs anchor commits by recording the linked model-state information within the distributed ledger to establish an immutable chronological sequence of collaborative model states available for forensic reconstruction and verification.

During operation, the participating network nodes execute the intrusion detection model within their respective Trusted Execution Environments to identify anomalous communication behaviour, generate encrypted vector representations and corresponding cryptographically verifiable detection records, and transmit the generated information to the Blockchain Coordination Layer. The Proof-of-Detection Consensus Engine coordinates collaborative validation by validating network nodes, while the Smart Contract processing unit records validated threat detections, propagates encrypted threat representations, manages collaborative model updates, and records cryptographically linked model-state information. The Cryptographic Services Layer performs encrypted computation, secure collaborative validation, and cryptographic proof generation supporting the collaborative validation workflow. Accordingly, the architecture illustrated in FIG. 3 provides the technical infrastructure supporting secure generation of cryptographically verifiable detection records, collaborative encrypted validation of detected threats, authenticated incorporation of collaborative model updates, and generation of cryptographically verifiable model provenance corresponding to validated threat detection events, consistent with the operations recited in the computer-implemented method and system claims.

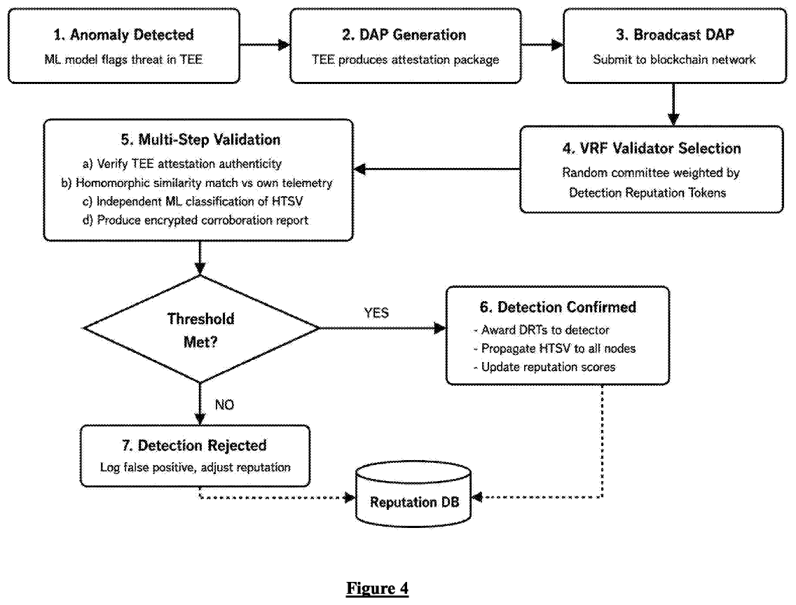

FIG. 4 illustrates an exemplary workflow of a Proof-of-Detection (PoD) consensus protocol executed by a decentralized collaborative cyber threat detection system for validating a detected cyber threat before recording the detected cyber threat within a distributed ledger and propagating corresponding threat information to participating network nodes.

Initially, at Step 1, a participating network node executes an intrusion detection model within a Trusted Execution Environment (TEE) to process monitored network telemetry and identify an anomalous traffic pattern corresponding to a potential cyber threat while maintaining the monitored network telemetry within the Trusted Execution Environment.

At Step 2, the Trusted Execution Environment generates a Detection Attestation Package (DAP) comprising cryptographic attestation information, a cryptographic digest representing the monitored network telemetry, intrusion detection model identification information, classification information, confidence information, and blockchain state information corresponding to the detected anomalous traffic pattern.

At Step 3, the participating network node broadcasts the Detection Attestation Package to participating network nodes maintaining the distributed ledger for collaborative validation.

At Step 4, the decentralized collaborative cyber threat detection system performs Verifiable Random Function (VRF)-based validator selection to identify validating network nodes responsible for evaluating the Detection Attestation Package. In one embodiment, validator selection is weighted according to Detection Reputation Tokens (DRTs) maintained for the participating network nodes.

At Step 5, each validating network node verifies the cryptographic attestation information contained in the Detection Attestation Package, generates an encrypted representation of locally monitored network telemetry, performs homomorphic similarity evaluation between the encrypted representation and the encrypted threat representation contained in the Detection Attestation Package, and independently evaluates the encrypted representation using a locally maintained intrusion detection model. The validating network node generates an encrypted corroboration report representing the validation result, and the encrypted corroboration reports generated by the validating network nodes are collectively evaluated to determine whether a predetermined validation threshold has been satisfied.

Responsive to determining that the predetermined validation threshold has been satisfied, the workflow proceeds to Step 6, wherein the decentralized collaborative cyber threat detection system records the validated Detection Attestation Package in the distributed ledger, updates the Detection Reputation Tokens associated with the originating and validating network nodes, and propagates the validated Homomorphic Threat Signature Vector (HTSV) for subsequent encrypted threat comparison.

Responsive to determining that the predetermined validation threshold has not been satisfied, the workflow proceeds to Step 7, wherein the Detection Attestation Package is rejected, corresponding rejection information is recorded in the distributed ledger, and the Detection Reputation Tokens associated with the originating network node are updated according to the validation outcome.

The Detection Reputation Tokens and associated reputation information are maintained in a Reputation Database (Reputation DB) and are subsequently utilized during Verifiable Random Function-based validator selection for future consensus validation operations.

Accordingly, the workflow illustrated in FIG. 4 provides authenticated Trusted Execution Environment attestation, reputation-based validator selection, encrypted collaborative validation, threshold-based consensus determination, blockchain recording of validated detections, reputation management, and propagation of validated encrypted threat information to support decentralized collaborative cyber threat detection and validation.

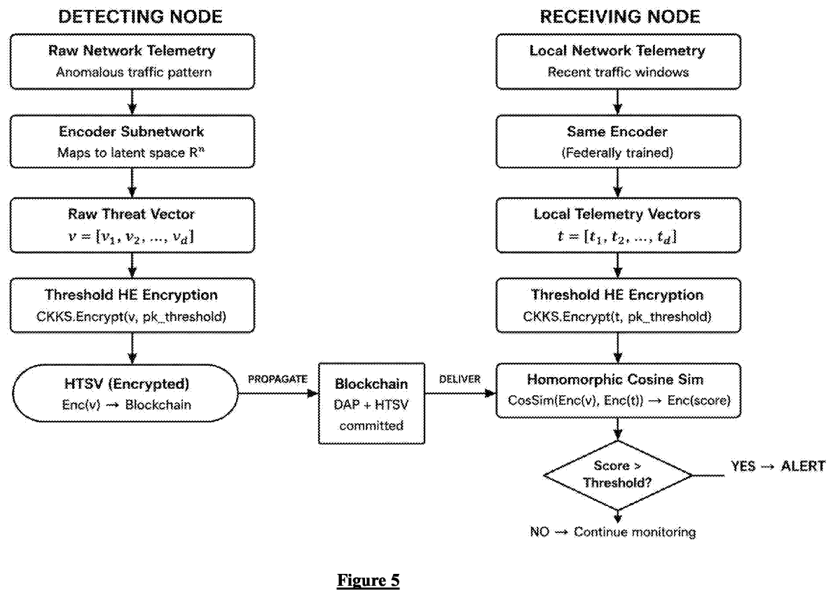

FIG. 5 illustrates an exemplary workflow for generating, distributing, and validating a Homomorphic Threat Signature Vector (HTSV) within the decentralized collaborative cyber threat detection system. The workflow enables participating network nodes to identify similar cyber threats by comparing encrypted threat representations without exposing monitored network telemetry or decrypting the encrypted threat representations during the validation process.

The workflow begins at a detecting node, wherein raw network telemetry generated from communication activities monitored by the detecting node is received and processed within a Trusted Execution Environment (TEE). The monitored network telemetry is supplied to an Encoder Subnetwork, which transforms the monitored network telemetry into a lower-dimensional latent representation while preserving distinguishing characteristics associated with the detected communication behaviour. In one embodiment, the Encoder Subnetwork generates a raw threat vector, represented as v=[v1, v2, . . . , vn], comprising numerical values collectively characterizing the detected anomalous traffic pattern.

The generated raw threat vector is subsequently processed by a Threshold Homomorphic Encryption (Threshold HE) unit. In one embodiment, the Threshold Homomorphic Encryption unit encrypts the raw threat vector using a Cheon-Kim-Kim-Song (CKKS) Homomorphic Encryption Scheme and a threshold encryption key shared among participating network nodes to generate an encrypted Homomorphic Threat Signature Vector (HTSV). Since the raw threat vector remains encrypted throughout subsequent processing, the encrypted Homomorphic Threat Signature Vector preserves confidentiality of the monitored network telemetry while permitting mathematical operations to be performed directly on the encrypted data.

Following encryption, the encrypted Homomorphic Threat Signature Vector is committed to the blockchain together with the corresponding Detection Attestation Package (DAP) generated by the detecting node. The blockchain records the encrypted Homomorphic Threat Signature Vector and the Detection Attestation Package as cryptographically verifiable information that becomes accessible to authorized participating network nodes without exposing the underlying monitored network telemetry or the unencrypted threat vector.

A receiving node independently performs a corresponding processing operation upon local network telemetry representing recently monitored communication activities. The local network telemetry is supplied to the same Encoder Subnetwork previously established through collaborative federated training, thereby ensuring that both the detecting node and the receiving node transform their respective network telemetry into a common latent feature space. The Encoder Subnetwork generates one or more local telemetry vectors, represented as t=[t1, t2, . . . , tn], corresponding to the locally monitored communication activities.

The generated local telemetry vectors are subsequently encrypted by the Threshold Homomorphic Encryption unit using the same threshold encryption key employed for generating the encrypted Homomorphic Threat Signature Vector. Consequently, both the encrypted Homomorphic Threat Signature Vector generated by the detecting node and the encrypted local telemetry vectors generated by the receiving node remain within an identical encrypted computational domain suitable for homomorphic processing.

The receiving node then performs homomorphic cosine similarity evaluation directly on the encrypted data. In one embodiment, a cosine similarity operation is executed between the encrypted Homomorphic Threat Signature Vector and the encrypted local telemetry vectors without decrypting either encrypted representation, thereby producing an encrypted similarity score representative of correspondence between the detected anomalous traffic pattern and the locally monitored communication activities. Because the similarity evaluation is performed entirely within the encrypted computational domain, confidentiality of both the originating network telemetry and the local network telemetry is preserved throughout the comparison process.

The encrypted similarity score is subsequently compared with a predetermined similarity threshold. When the encrypted similarity score satisfies or exceeds the predetermined similarity threshold, the receiving node determines that the locally monitored communication activities correspond to the same or substantially similar cyber threat represented by the encrypted Homomorphic Threat Signature Vector. Responsive to the positive determination, the receiving node generates corroboration information for submission during the collaborative validation process. Conversely, when the encrypted similarity score does not satisfy the predetermined similarity threshold, the receiving node continues monitoring subsequently received network telemetry without generating corroboration information for the detected threat.

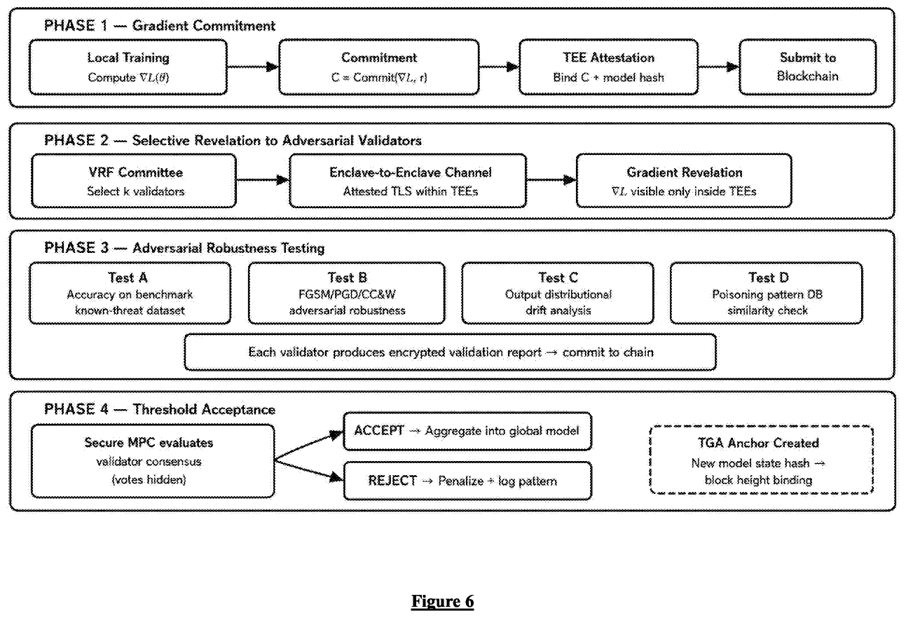

FIG. 6 illustrates an exemplary Multi-Phase Adversarial Consensus Validation (MACV) protocol executed for validating collaborative intrusion detection model updates before incorporation into a collaboratively maintained intrusion detection model. The protocol comprises four sequential phases including gradient commitment, selective revelation to adversarial validators, adversarial robustness testing, and threshold-based acceptance, thereby enabling collaborative model updates to be verified without exposing model parameters to unauthorized entities while preventing incorporation of malicious or poisoned model updates.

During Phase 1, a participating network node performs local training using network telemetry available at the participating network node to generate a local model update represented by a gradient vector (∇L). Rather than immediately transmitting the generated gradient vector to participating network nodes, the one or more processors generate a cryptographic commitment represented as C=Commit(∇L, r), wherein r represents a cryptographic random value used during commitment generation. The cryptographic commitment permits subsequent verification of the gradient vector while preventing disclosure of the gradient vector before validation. The one or more processors subsequently generate Trusted Execution Environment (TEE) attestation information by cryptographically binding the generated cryptographic commitment with a cryptographic hash representing the collaborative intrusion detection model from which the local model update was derived. The resulting authenticated commitment is transmitted to the distributed ledger and recorded as an immutable commitment associated with the local model update, thereby enabling subsequent verification of model integrity and model provenance.

During Phase 2, the decentralized collaborative cyber threat detection system performs selective revelation of the committed local model update. Initially, a Verifiable Random Function (VRF) is executed to select a committee comprising k validating network nodes from the participating network nodes. The Verifiable Random Function produces a deterministic yet unpredictable validator selection result while preventing advance prediction of the validating network nodes responsible for evaluating the committed model update. Following validator selection, authenticated enclave-to-enclave communication channels are established between the Trusted Execution Environment of the originating network node and the Trusted Execution Environments of the selected validating network nodes. In one embodiment, the enclave-to-enclave communication channels comprise authenticated Transport Layer Security (TLS) sessions established entirely between Trusted Execution Environments. The originating network node subsequently reveals the gradient vector only within the authenticated Trusted Execution Environments of the selected validating network nodes, such that the gradient vector remains inaccessible to software executing outside the Trusted Execution Environments throughout the validation process.

During Phase 3, the selected validating network nodes independently perform adversarial robustness testing upon the revealed gradient vector before authorizing incorporation of the corresponding model update into the collaborative intrusion detection model. In one embodiment, the adversarial robustness testing comprises multiple independent validation procedures executed in parallel. A first validation procedure (Test A) evaluates prediction accuracy of the model update using a benchmark dataset containing known cyber threat patterns. A second validation procedure (Test B) evaluates resistance of the model update against adversarial perturbation attacks using Fast Gradient Sign Method (FGSM), Projected Gradient Descent (PGD), and Carlini and Wagner (C&W) attack techniques to determine whether the model update remains robust under adversarial input perturbations. A third validation procedure (Test C) evaluates statistical distribution of prediction outputs generated by the model update to identify abnormal output drift indicating potential degradation or manipulation of the collaborative intrusion detection model. A fourth validation procedure (Test D) compares the revealed gradient vector with entries maintained within a poisoning-pattern database to determine whether the revealed gradient vector exhibits similarity with previously identified malicious or poisoned model updates. Upon completion of the validation procedures, each validating network node generates an encrypted validation report representing results of the performed adversarial robustness testing and commits the encrypted validation report to the distributed ledger without exposing intermediate validation information.

During Phase 4, the decentralized collaborative cyber threat detection system performs threshold-based acceptance of the proposed model update. The encrypted validation reports generated by the validating network nodes are processed using Secure Multi-Party Computation (Secure MPC) such that individual validator decisions remain confidential while permitting collaborative determination of whether the proposed model update satisfies predetermined acceptance criteria. In one embodiment, Secure Multi-Party Computation evaluates validator consensus while maintaining individual validator votes hidden from other participating network nodes. Responsive to determining that the validator consensus satisfies the predetermined acceptance criteria, the proposed model update is accepted and incorporated into the collaboratively maintained intrusion detection model. Conversely, responsive to determining that the validator consensus does not satisfy the predetermined acceptance criteria, the proposed model update is rejected, information representing the rejected model update is recorded within the distributed ledger, and the originating network node is subjected to a penalty process that adjusts validator reputation information and records characteristics associated with the rejected model update for subsequent poisoning-pattern detection.

Following successful acceptance of the proposed model update, the one or more processors generate a Temporal Gradient Anchoring (TGA) record by generating a cryptographic hash representing the newly accepted collaborative intrusion detection model state, cryptographically linking the generated cryptographic hash with a cryptographic digest corresponding to the immediately preceding collaborative model state and a corresponding block maintained within the distributed ledger, and recording the linked information within the distributed ledger to establish an immutable chronological sequence of accepted collaborative model states. The generated Temporal Gradient Anchoring record enables subsequent verification of the origin and evolution of the collaboratively maintained intrusion detection model while preserving cryptographic linkage between successive collaborative model states.

Accordingly, the workflow illustrated in FIG. 6 enables secure commitment of collaborative model updates, controlled disclosure of committed model updates only to authenticated validator enclaves, multi-stage adversarial robustness evaluation, confidential consensus determination through Secure Multi-Party Computation, and cryptographically verifiable recording of accepted collaborative model states. The operations performed during the four phases support the computer-implemented method and system by enabling collaborative validation of model updates, secure incorporation of validated model parameters, generation of immutable model-state provenance, and protection of the collaborative intrusion detection model against adversarial manipulation and model-poisoning attacks.

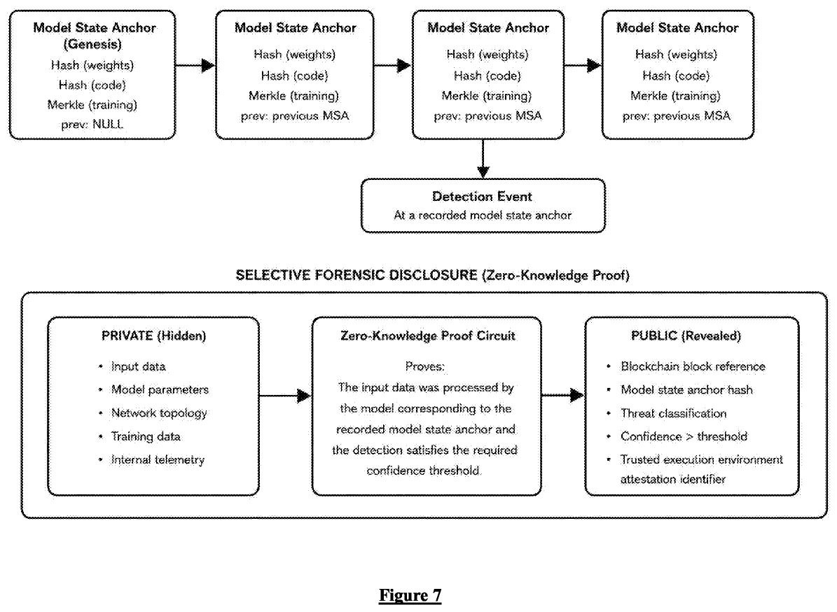

FIG. 7 illustrates an exemplary implementation of Temporal Gradient Anchoring (TGA) and Selective Forensic Disclosure (SFD) using Zero-Knowledge Proofs (ZKP) for maintaining cryptographically verifiable provenance of collaborative intrusion detection model states and for verifying recorded cyber threat detection events without revealing confidential operational information.

The upper portion of FIG. 7 illustrates a sequence of Model State Anchors (MSAs) maintained within the distributed ledger. Beginning with a Genesis Model State Anchor, each subsequently generated Model State Anchor corresponds to a collaborative intrusion detection model state generated after incorporation of an accepted collaborative model update. Each Model State Anchor comprises a cryptographic hash representing the collaborative intrusion detection model parameters, a cryptographic hash representing the corresponding model implementation, a Merkle tree root representing training information associated with the accepted collaborative model update, and a cryptographic reference to the immediately preceding Model State Anchor. The model-state history management unit records each Model State Anchor within the distributed ledger and cryptographically links successive Model State Anchors to establish an immutable chronological record representing evolution of the collaboratively maintained intrusion detection model.

As further illustrated, a Detection Event is associated with a corresponding Model State Anchor recorded within the distributed ledger. Associating the Detection Event with the corresponding Model State Anchor enables subsequent identification of the collaborative intrusion detection model state responsible for generating the validated detection and permits reconstruction of the historical model state during verification or forensic analysis.

The lower portion of FIG. 7 illustrates the Selective Forensic Disclosure protocol implemented by the cryptographic proof generation unit using Zero-Knowledge Proofs. The protocol separates information into private information and publicly disclosed information. The private information comprises monitored input data, collaborative intrusion detection model parameters, network topology information, training information, and internal network telemetry maintained by participating network nodes. The publicly disclosed information comprises a blockchain block reference, a cryptographic hash corresponding to the associated Model State Anchor, a threat classification associated with the Detection Event, a confidence value satisfying a predetermined validation threshold, and an identifier corresponding to the Trusted Execution Environment that generated the validated Detection Event.

To generate the cryptographic proof, the cryptographic proof generation unit constructs a Zero-Knowledge Proof circuit configured to verify that the monitored input data was processed by the collaborative intrusion detection model corresponding to the identified Model State Anchor and that the resulting Detection Event satisfies the predetermined confidence threshold, without revealing the monitored input data, collaborative intrusion detection model parameters, training information, network topology information, or internal network telemetry. An authorized verifier retrieves the blockchain block reference and the corresponding Model State Anchor from the distributed ledger and verifies the generated Zero-Knowledge Proof using the publicly disclosed information to confirm authenticity of the Detection Event without obtaining access to the private information The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible.

1. A computer-implemented method for decentralized adversarial-resilient cyber threat detection, the method being performed by one or more processors in communication with a memory, the computer-implemented method comprising:
receiving, by the one or more processors, network telemetry associated with one or more participating network nodes and processing the network telemetry using an intrusion detection model operating within a hardware-attested trusted execution environment to generate processed network telemetry and to identify a network event corresponding to a potential cyber threat, wherein processing the network telemetry comprises generating a latent feature representation corresponding to an identified network event, generating one or more cryptographic commitments representative of the processed network telemetry, and associating the latent feature representation with identity information and version information of the intrusion detection model maintained within the hardware-attested trusted execution environment;
generating, by the one or more processors, a detection attestation package corresponding to the identified network event, wherein generating the detection attestation package comprises encrypting the latent feature representation using a threshold homomorphic encryption scheme to obtain an encrypted threat signature, cryptographically binding the encrypted threat signature with the cryptographic commitment representative, the identity information, the version information, and a blockchain state reference corresponding to a current blockchain state to produce a cryptographically verifiable threat detection record, and transmitting the detection attestation package to a blockchain network;
processing, by the one or more processors, the detection attestation package to validate the identified network event, wherein processing the detection attestation package comprises verifying authenticity of a hardware attestation associated with the detection attestation package, selecting a plurality of validator nodes according to a blockchain consensus procedure to obtain selected validator nodes, generating encrypted telemetry representations from network telemetry locally available at the selected validator nodes using a feature transformation corresponding to generation of the encrypted threat signature, performing homomorphic similarity computation between the encrypted threat signature and the encrypted telemetry representations while maintaining the encrypted threat signature and the encrypted telemetry representations in encrypted form throughout the homomorphic similarity computation, generating encrypted corroboration information according to similarity results obtained from the homomorphic similarity computation, and determining whether the encrypted corroboration information satisfies a consensus validation condition;
recording, by the one or more processors, the identified network event responsive to determining that the consensus validation condition is satisfied, wherein recording comprises storing the encrypted threat signature and the detection attestation package within a blockchain record, updating a reputation value associated with the participating network node according to a validated network event to obtain an updated reputation value, associating the updated reputation value with subsequent collaborative model contribution and blockchain participation, and propagating the encrypted threat signature to participating network nodes for encrypted comparison with locally generated encrypted telemetry representations without exposing underlying network telemetry associated with the participating network nodes;
processing, by the one or more processors, collaborative model updates associated with the participating network nodes, wherein processing the collaborative model updates comprises receiving cryptographic commitments corresponding to proposed model updates, selectively exposing the proposed model updates to the selected validator nodes through authenticated secure communication established between hardware-attested trusted execution environments, generating encrypted validation information corresponding to robustness evaluation performed for the proposed model updates, determining acceptance of the proposed model updates according to the encrypted validation information received from the selected validator nodes, incorporating accepted model updates into a collaborative model state, rejecting model updates failing acceptance, and recording an outcome corresponding to each proposed model update within the blockchain record;
maintaining, by the one or more processors, a verifiable model-state history corresponding to the collaborative model state, wherein maintaining the verifiable model-state history comprises generating a model-state anchor for each accepted model update, cryptographically linking each model-state anchor with a preceding model-state anchor and a blockchain block corresponding to acceptance of the accepted model update, storing cryptographic hashes representative of the collaborative model state and training-data commitments within the model-state anchor, and preserving a chronological model provenance corresponding to successive collaborative model updates; and
generating, by the one or more processors, responsive to receipt of a verification request, a cryptographic proof corresponding to a recorded network event, wherein generating the cryptographic proof comprises retrieving a model-state anchor corresponding to the recorded network event, constructing the cryptographic proof using the model-state anchor, the blockchain record, and the hardware attestation associated with the detection attestation package, and providing the cryptographic proof for verification of the recorded network event while retaining confidentiality of the network telemetry, the collaborative model state, and the encrypted threat signature, wherein processing the network telemetry comprises sequentially extracting network communication attributes from a plurality of telemetry records, normalizing the network communication attributes into a common representation, correlating the network communication attributes across multiple communication sessions associated with the participating network node to construct a unified behavioural representation of the network event, processing the unified behavioural representation using the intrusion detection model to generate intermediate feature values representing communication behaviour associated with the network event, transforming the intermediate feature values into the latent feature representation while maintaining positional correspondence between the intermediate feature values and the latent feature representation, generating the cryptographic commitment from the network telemetry associated with the network event after generation of the latent feature representation, and associating the cryptographic commitment with the identity information and the version information of the intrusion detection model before generation of the detection attestation package, and wherein generating the detection attestation package comprises generating the encrypted threat signature from the latent feature representation before generation of the blockchain state reference, combining the encrypted threat signature, the cryptographic commitment, the identity information, the version information and the blockchain state reference into a single ordered data structure, generating a cryptographic digest over the single ordered data structure, incorporating the cryptographic digest into the detection attestation package as an integrity verification value, verifying consistency between the identity information and the version information before transmission of the detection attestation package, and preventing modification of the encrypted threat signature after generation of the cryptographic digest by maintaining the cryptographic digest in association with transmitted detection attestation package.

2. The computer-implemented method of claim 1, wherein processing the detection attestation package comprises selecting the plurality of validator nodes according to participation information maintained within the blockchain network, distributing the detection attestation package to each selected validator node without exposing the network telemetry corresponding to the identified network event, generating, at each selected validator node, the encrypted telemetry representations from locally available network telemetry using the feature transformation corresponding to generation of the encrypted threat signature, performing homomorphic similarity computation independently for each encrypted telemetry representation received from the selected validator node, generating the encrypted corroboration information individually for respective validator nodes, aggregating the encrypted corroboration information received from the selected validator node into a consolidated validation dataset, and determining satisfaction of the consensus validation condition according to the consolidated validation dataset.

3. The computer-implemented method of claim 1, wherein performing the homomorphic similarity computation comprises maintaining the encrypted threat signature and the encrypted telemetry representations in encrypted form throughout generation of intermediate computational values associated with the homomorphic similarity computation, repeatedly processing corresponding portions of the encrypted threat signature and the encrypted telemetry representations to generate encrypted partial similarity values, combining the encrypted partial similarity values into an encrypted similarity result, processing the encrypted similarity result to determine whether a similarity condition has been satisfied without reconstructing either the latent feature representation or the locally generated encrypted telemetry representations, and generating the encrypted corroboration information only after determination of the similarity condition.

4. The computer-implemented method of claim 1, wherein recording the identified network event comprises generating a blockchain record containing the encrypted threat signature, the detection attestation package, the encrypted corroboration information and the updated reputation value, associating the blockchain record with the blockchain state reference corresponding to validation of the identified network event, storing the blockchain record in chronological association with previously validated network events, propagating the encrypted threat signature from the blockchain record to participating network nodes, receiving acknowledgement information corresponding to receipt of the encrypted threat signature by the participating network nodes, and updating the reputation value according to completion of propagation of the encrypted threat signature.

5. The computer-implemented method of claim 1, wherein processing the collaborative model updates comprises receiving the cryptographic commitments corresponding to proposed model updates from a plurality of participating network nodes, associating each proposed model update with the corresponding identity information and version information of the intrusion detection model, selectively exposing each proposed model update through authenticated secure communication established between hardware-attested trusted execution environments, generating encrypted validation information independently for respective proposed model updates, comparing the encrypted validation information corresponding to the proposed model updates before determination of acceptance, incorporating only accepted model updates into the collaborative model state according to the determining of acceptance, and recording the accepted model updates and rejected model updates as separate blockchain records associated with corresponding blockchain blocks.

6. The computer-implemented method of claim 1, wherein maintaining the verifiable model-state history comprises generating the model-state anchor immediately after incorporation of each accepted model update into the collaborative model state, generating a cryptographic hash representative of the collaborative model state after incorporation of the accepted model update, associating the cryptographic hash representative with a blockchain block corresponding to the accepted model update, generating a chained reference linking the model-state anchor with a preceding model-state anchor, storing the cryptographic hash representative corresponding to the collaborative model state and the training-data commitments within the model-state anchor, and preserving chronological association between successive model-state anchors according to the blockchain block corresponding to the accepted model updates.

7. The computer-implemented method of claim 1, wherein generating the cryptographic proof comprises identifying the blockchain record corresponding to the recorded network event, retrieving the model-state anchor associated with the blockchain record, retrieving the hardware attestation associated with the detection attestation package corresponding to the recorded network event, generating proof data representing association of the recorded network event with the blockchain record, the model-state anchor and the hardware attestation, verifying consistency among the blockchain record, the model-state anchor and the hardware attestation before generation of the cryptographic proof, and providing generated cryptographic proof without exposing the network telemetry, the latent feature representation, the encrypted telemetry representations or the collaborative model state.

8. The computer-implemented method of claim 1, wherein generating the latent feature representation comprises sequentially processing feature values extracted from the network telemetry to generate intermediate feature groups representative of communication behaviour associated with the identified network event, maintaining positional correspondence between the intermediate feature groups representative and respective portions of the network telemetry during generation of the latent feature representation, generating the latent feature representation from the intermediate feature groups representative without storing the intermediate feature groups representative within the blockchain record, and retaining the latent feature representation within the hardware-attested trusted execution environment until completion of generation of the encrypted threat signature.

9. The computer-implemented method of claim 1, wherein encrypting the latent feature representation comprises partitioning the latent feature representation into a plurality of encrypted computational segments, generating encrypted values corresponding to the computational segments using a common threshold encryption context, associating the encrypted computational segments to preserve positional correspondence existing in the latent feature representation, and generating the encrypted threat signature from the encrypted computational segments without reconstructing the latent feature representation following encryption, and wherein generating the detection attestation package further comprises generating a cryptographic integrity value over the encrypted threat signature, the cryptographic commitment, the identity information, the version information and the blockchain state reference in a predetermined sequence, storing the cryptographic integrity value within the detection attestation package, and validating the cryptographic integrity value before processing the detection attestation package for consensus validation.

10. The computer-implemented method of claim 1, wherein processing the detection attestation package further comprises independently processing the encrypted threat signature against respective encrypted telemetry representations received from the selected validator nodes, generating individual encrypted similarity results corresponding to the respective encrypted telemetry representations, arranging the individual encrypted similarity results into a consolidated validation structure preserving validator-specific correspondence, and determining the consensus validation condition using the consolidated validation structure.

11. The computer-implemented method of claim 1, wherein generating the encrypted corroboration information comprises generating validator-specific encrypted corroboration values corresponding to encrypted similarity results, associating each encrypted corroboration value with the blockchain state reference corresponding to received detection attestation package, combining the validator-specific encrypted corroboration values into a collective corroboration record, and processing the collective corroboration record during determination of the consensus validation condition, and wherein updating the reputation value comprises identifying previously validated network events associated with the participating network node, determining a cumulative validation history from the previously validated network events and the identified network event, generating an updated reputation value according to the cumulative validation history, associating the updated reputation value with the participating network node within the blockchain record, and retrieving the updated reputation value during subsequent validator selection and collaborative model update processing.

12. The computer-implemented method of claim 1, wherein processing the collaborative model updates further comprises generating a cryptographic commitment corresponding to each proposed model update before transmitting the proposed model update for validation, maintaining association between the cryptographic commitment and the corresponding proposed model update throughout validation, verifying consistency between the proposed model update and the corresponding cryptographic commitment before determination of acceptance, and discarding proposed model updates determined to be inconsistent with the corresponding cryptographic commitment, and wherein incorporating the accepted model updates into the collaborative model state comprises sequentially incorporating accepted model updates according to blockchain ordering, generating an updated collaborative model state after incorporation of each accepted model update, generating a cryptographic representation corresponding to the updated collaborative model state, and associating the cryptographic representation with the blockchain block corresponding to incorporation of the accepted model update.

13. The computer-implemented method of claim 1, wherein generating the model-state anchor comprises generating a cryptographic hash corresponding to the collaborative model state, generating a cryptographic hash corresponding to training-data commitments associated with the collaborative model state, generating a chained reference corresponding to a preceding model-state anchor, combining the cryptographic hash and the chained reference into the model-state anchor, and associating the model-state anchor with the blockchain block corresponding to acceptance of the collaborative model update.

14. The computer-implemented method of claim 1, wherein generating the detection attestation package comprises generating a first cryptographic digest corresponding to the encrypted threat signature, generating a second cryptographic digest corresponding to the cryptographic commitment, arranging the first cryptographic digest, the second cryptographic digest, the identity information, the version information and the blockchain state reference in a predetermined sequence to generate a verification record, generating a verification digest from the verification record, incorporating the verification digest within the detection attestation package before transmission to the blockchain network, and maintaining the encrypted threat signature and the cryptographic commitment unchanged following generation of the verification digest until completion of validation of the detection attestation package.

15. The computer-implemented method of claim 1, wherein processing the detection attestation package comprises generating a validator-specific encrypted corroboration entry for each selected validator node, associating each validator-specific encrypted corroboration entry with a validator identifier and the blockchain state reference corresponding to the detection attestation package, arranging the validator-specific encrypted corroboration entries into an encrypted corroboration dataset while preserving correspondence between the validator identifiers and respective validator-specific encrypted corroboration entries, and determining the consensus validation condition by processing the encrypted corroboration dataset.

16. The computer-implemented method of claim 1, wherein the encrypted threat signature is maintained in association with the detection attestation package throughout validation of the identified network event, transferring the encrypted threat signature into the blockchain record responsive to determining that the consensus validation condition is satisfied, propagating the encrypted threat signature to participating network nodes from the blockchain record, associating the encrypted threat signature with the blockchain record during maintenance of the verifiable model-state history, and retrieving the encrypted threat signature from the blockchain record during generation of the cryptographic proof, and wherein recording the identified network event comprises constructing the blockchain record by sequentially incorporating the detection attestation package, the encrypted corroboration information, the updated reputation value and the blockchain state reference into a verification structure, generating a cryptographic hash representative of the verification structure, storing the verification structure and the cryptographic hash representative together within the blockchain record, and associating the blockchain record with a subsequent blockchain block for maintaining chronological correspondence between validated network events.

17. The computer-implemented method of claim 1, wherein processing the detection attestation package comprises verifying correspondence between the version information associated with the encrypted threat signature and version information associated with the intrusion detection model of each selected validator node before generation of the encrypted telemetry representations, processing the encrypted threat signature using encrypted telemetry representations generated by validator nodes determined to have corresponding version information, excluding encrypted telemetry representations generated by validator nodes determined not to have corresponding version information from determination of the consensus validation condition, and determining the consensus validation condition using encrypted corroboration information generated from the encrypted telemetry representations corresponding to the validator nodes having the corresponding version information.

18. The computer-implemented method of claim 1, wherein processing the collaborative model updates comprises identifying the collaborative model state associated with the version information contained in the detection attestation package, verifying correspondence between the collaborative model state and the model-state anchor associated with an accepted collaborative model update, incorporating a subsequent accepted collaborative model update responsive to successful verification of the correspondence, and generating a subsequent model-state anchor corresponding to the incorporated collaborative model update.

19. A decentralized adversarial-resilient cyber threat detection system configured to perform the computer-implemented method of claim 1, the system comprising:
one or more processors; and
a memory communicatively coupled to the one or more processors and storing executable data including network telemetry, latent feature representations, cryptographic commitments, identity information, version information of an intrusion detection model, detection attestation packages, encrypted threat signatures, blockchain state references, encrypted telemetry representations, encrypted corroboration information, collaborative model states, blockchain records, model-state anchors, and cryptographic proofs, wherein the one or more processors are configured to:
receive network telemetry associated with a participating network node and process the network telemetry using an intrusion detection model operating within a hardware-attested trusted execution environment to generate processed network telemetry and to identify a network event corresponding to a potential cyber threat, generate a latent feature representation corresponding to an identified network event, generate a cryptographic commitment representative of the processed network telemetry, and associate the latent feature representations with the identity information and the version information of the intrusion detection model maintained within the hardware-attested trusted execution environment;
generate a detection attestation package corresponding to the identified network event by encrypting the latent feature representations using a threshold homomorphic encryption scheme to obtain an encrypted threat signature, cryptographically binding the encrypted threat signature with the cryptographic commitment, the identity information, the version information and a blockchain state reference corresponding to a current blockchain state to produce a cryptographically verifiable threat detection record, and transmit the detection attestation package to a blockchain network;
process the detection attestation package to validate the identified network event by verifying authenticity of a hardware attestation associated with the detection attestation package, selecting a plurality of validator nodes according to a blockchain consensus procedure to obtain selected validator nodes, generating encrypted telemetry representations from network telemetry locally available at the selected validator nodes using a feature transformation corresponding to generation of the encrypted threat signature, performing homomorphic similarity computation between the encrypted threat signature and the encrypted telemetry representations while maintaining the encrypted threat signature and the encrypted telemetry representations in encrypted form throughout the homomorphic similarity computation, generating encrypted corroboration information according to similarity results obtained from the homomorphic similarity computation, and determining whether the encrypted corroboration information satisfies a consensus validation condition;
record the identified network event responsive to determining that the consensus validation condition is satisfied by storing the encrypted threat signature and the detection attestation package within a blockchain record, updating a reputation value associated with the participating network node according to a validated network event to obtain an updated reputation value, associating the updated reputation value with subsequent collaborative model contribution and blockchain participation, and propagating the encrypted threat signature to participating network nodes for encrypted comparison with locally generated encrypted telemetry representations without exposing underlying network telemetry associated with the participating network nodes;
process collaborative model updates associated with the participating network nodes by receiving cryptographic commitments corresponding to proposed model updates, selectively exposing the proposed model updates to the selected validator nodes through authenticated secure communication established between hardware-attested trusted execution environments, generating encrypted validation information corresponding to robustness evaluation performed for the proposed model updates, determining acceptance of the proposed model updates according to the encrypted validation information received from the selected validator nodes, incorporating accepted model updates into a collaborative model state, rejecting model updates failing acceptance, and recording an outcome corresponding to each proposed model update within the blockchain records;
maintain a verifiable model-state history corresponding to the collaborative model states by generating a model-state anchor for each accepted model update, cryptographically linking each model-state anchor with a preceding model-state anchor and a blockchain block corresponding to acceptance of the accepted model update, storing cryptographic hashes representative of the collaborative model states and training-data commitments within the model-state anchors, and preserving a chronological model provenance corresponding to successive collaborative model updates; and
generate, responsive to receipt of a verification request, a cryptographic proof corresponding to a recorded network event by retrieving a model-state anchor corresponding to the recorded network event, constructing the cryptographic proofs using the model-state anchors, the blockchain records and the hardware attestation associated with the detection attestation package, and providing the cryptographic proofs for verification of the recorded network event while retaining confidentiality of the network telemetry, the collaborative model states and the encrypted threat signature.
